(19) United States
(12) Patent Application Publication
(10) Pub. No.: US 2025/0005555 A1
(43) Pub. Date: Jan. 2, 2025

(54) SYSTEMS AND METHODS TO PROVIDE CONTACTLESS CARDS FOR TRANSACTIONS

(71) Applicant: Capital One Services, LLC, McLean, VA (US)

(72) Inventors: Bob Uni Koshy, Henrico, VA (US); Narmeen Rahman, New York, NY (US); Marianne Huang, Palo Alto, CA (US); Edward Michael Abdullah, Bluffton, SC (US)

(73) Assignee: Capital One Services, LLC, McLean, VA (US)

(21) Appl. No.: 18/759,533

(22) Filed: Jun. 28, 2024

Related U.S. Application Data
(60) Provisional application No. 63/524,601, filed on Jun. 30, 2023.

(51) Int. Cl. G06Q 20/34

(52) U.S. Cl. CPC G06Q 20/352

(57) ABSTRACT

Systems and methods to provide contactless cards for transactions are disclosed. In an exemplary transaction provisioning system, an authentication server receives, from a backend server, a session creation request for provisioning a contactless card and transmits, to the backend server, a session creation response and a session token. The authentication server receives, from the backend server, an authentication process function request that includes encrypted data associated with the contactless card, decrypts the encrypted data to yield a decrypted authentication code, and compares the decrypted authentication code to an expected authentication code. After an unsuccessful comparison, the authentication server transmits, to the backend server, a notification indicating an unsuccessful authentication to the backend server. After a successful comparison, the authentication server transmits, to the backend server a session identifier associated with the session creation request and a funding primary account number.

### CROSS-REFERENCE TO RELATED APPLICATIONS

The present application claims the benefit of priority to U.S. Provisional Patent Application No. 63/524,601, filed Jun. 30, 2023, the contents of which are hereby incorporated by reference in their entirety.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity. Accordingly, there is a need to provide businesses and users with an appropriate solution that overcomes current deficiencies to provide data security, authentication, and verification for contactless card.

### BRIEF SUMMARY

In one aspect, a transaction provisioning system, includes an authentication server including a processor, and a memory storing an expected authentication code for a contactless card, where the authentication server receives, from a backend server, a session creation request for provisioning the contactless card, transmits, to the backend server, a session creation response and a session token, receives, from the backend server, an authentication process function request that includes encrypted data associated with the contactless card, decrypts the encrypted data to yield a decrypted authentication code, compares the decrypted authentication code to the expected authentication code, transmits, after an unsuccessful comparison, a notification indicating an unsuccessful authentication to the backend server, and transmits, after a successful comparison, a session identifier associated with the session creation request and a funding primary account number.

The transaction provisioning system may also include where the authentication server receives, from the backend server, a request to establish a virtual card number (VCN) autofill procedure, receives, from a token server, an eligibility request associated with the contactless card, and transmit, to the token server after determining the contactless card is eligible, a notification indicating eligibility.

The transaction provisioning system may also include where the authentication function request further includes at least one selected from the group of the session identifier, a consent date, and a device identifier.

The transaction provisioning system may also include where the authentication function request further includes a wallet identifier associated with a digital wallet.

The transaction provisioning system may also include where the authentication function request includes one or more risk signals.

The transaction provisioning system may also include where the one or more risk signals includes at least one selected from the group of a device phone number, an email address, an account risk score, a device risk score, an internet protocol (IP) address, a device geolocation, an account to device bonding identifier, and a device to account bonding age.

The transaction provisioning system may also include where the device phone number and the email address are hashed.

The transaction provisioning system may also include where the authentication process function request further includes one or more risk signals, and the one or more risk signals are generated by the backend server.

The transaction provisioning system may also include where prior to transmitting the session identifier and the encrypted funding primary account number, the authentication server assesses the one or more risk signals, and transmits, to the backend server after determining the authentication process function request is fraudulent based on the one or more risk signals, a notification indicating a fraudulent transaction.

The transaction provisioning system may also include where the authentication server assesses the one or more risk signals, and determines, prior to transmitting the session identifier and the encrypted funding primary account number, that the authentication process function request is not fraudulent based on the one or more risk signals.

In one aspect, a transaction provisioning method performed by an authentication server includes a processor and a memory, the method includes receiving, from a backend server, a session creation request for provisioning a contactless card, transmitting, to the backend server, a session creation response and a session token, receiving, from the backend server, an authentication process function request includes encrypted data associated with the contactless card, decrypting the encrypted data to yield a decrypted authentication code, comparing the decrypted authentication code to an expected authentication code associated for the contactless card, transmitting, after an unsuccessful comparison, a notification indicating an unsuccessful authentication to the backend server, and transmitting, after a successful comparison, a session identifier associated with the session creation request and a funding primary account number.

The method may also include where the funding primary account number is encrypted prior to transmission.

The method may also include where the authentication process function request further includes one or more risk signals, and the one or more risk signals are generated by the backend server.

The method may also include further includes, prior to transmitting the session identifier and the encrypted funding primary account number assessing the one or more risk signals, and transmitting, to the backend server after determining the authentication process function request is fraudulent based on the one or more risk signals, a notification indicating a fraudulent transaction.

The method may also include further includes assessing the one or more risk signals, and determining, prior to transmitting the session identifier and the encrypted funding primary account number, that the authentication process function request is not fraudulent based on the one or more risk signals.

The method may also include where the authentication function request further includes at least one selected from the group of the session identifier, a consent date, and a device identifier.

The method may also include where the authentication function request further includes a wallet identifier associated with a digital wallet.

In one aspect, a non-transitory computer readable medium containing instructions, where, upon execution by a processor, the instructions cause the processor to perform procedures includes receiving, from a backend server, a session creation request for provisioning a contactless card, transmitting, to the backend server, a session creation response and a session token, receiving, from the backend server, an authentication process function request includes encrypted data associated with the contactless card, decrypting the encrypted data to yield a decrypted authentication code, comparing the decrypted authentication code to an expected authentication code associated for the contactless card, transmitting, after an unsuccessful comparison, a notification indicating an unsuccessful authentication to the backend server, and transmitting, after a successful comparison, a session identifier associated with the session creation request and a funding primary account number.

The non-transitory computer readable medium may also include the procedures further includes receiving, from the backend server, a request to establish a virtual card number (VCN) autofill procedure, receiving, from a token server, an eligibility request associated with the contactless card, and transmitting, to the token server after determining the contactless card is eligible, a notification indicating eligibility.

The non-transitory computer readable medium may also include where the authentication function request further includes at least one selected from the group of the session identifier, a consent date, and a device identifier.

Other technical features may be readily apparent to one skilled in the art from the following figures, descriptions, and claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows.

FIG. 1 illustrates a data transmission system according to an example embodiment.

FIG. 2 illustrates a data transmission system according to an example embodiment.

FIG. 3 illustrates a contactless card in accordance with one embodiment.

FIG. 4 illustrates components of a contactless card according to an example embodiment.

FIG. 5 illustrates a sequence diagram according to an example embodiment.

FIG. 6 illustrates a data structure according to an example embodiment.

FIG. 7 illustrates a key system according to an example embodiment.

FIG. 8 illustrates a method according to an example embodiment.

FIG. 9 illustrates a method according to an example embodiment.

FIG. 10 illustrates a method according to an example embodiment.

FIG. 11 illustrates a system according to an example embodiment.

FIG. 12 illustrates a sequence diagram according to an example embodiment.

FIG. 13A illustrates a sequence diagram according to an example embodiment.

FIG. 13B illustrates a sequence diagram according to an example embodiment.

FIG. 13C illustrates a sequence diagram according to an example embodiment.

FIG. 14 illustrates a data structure according to an example embodiment.

FIG. 15 illustrates a method according to an example embodiment.

FIG. 16 illustrates a system according to an example embodiment.

FIG. 17 illustrates a method according to an example embodiment.

FIG. 18 illustrates a sequence diagram according to an example embodiment.

FIG. 19A illustrates a sequence diagram according to an example embodiment.

FIG. 19B illustrates a sequence diagram according to an example embodiment.

FIG. 20A illustrates a sequence diagram according to an example embodiment.

FIG. 20B illustrates a sequence diagram according to an example embodiment.

FIG. 21 illustrates a computer architecture according to an example embodiment.

FIG. 22 illustrates a communications architecture according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Example embodiments herein disclose systems and methods for the secure cryptographic authentication of contactless cards to perform transactions, including without limitation, financial transactions. As contactless cards have become ubiquitous, it is necessary for many entities, to be able to securely communicate, authenticate, and perform transactions with contactless cards.

The systems and methods described herein to provide data security, authentication, and transactions for contactless cards provide many advantages. For example, the systems and methods can provide a better customer experience and higher conversion rates. In some examples, conversion rates may be calculated for card provisioning, card account filing, and transactions.

As another example, the systems and methods described herein allow for a user to add a card for use with a transaction processing entity with a tap of the card on a client device. A user can interact with a user interface, such as a user interface presented by the transaction processing entity, for the card tap, a read of the card by the client device, provision of terms and conditions and receipt of a user consent, and the provisioning of the card to the transaction processing entity.

As another example, the systems and methods described herein allow for the establishment of data exchanges between the transaction processing entity and other entities, such as a card entity (e.g., a card issuing entity, a card validating entity). Exemplary data to be exchanged can include a phone number (e.g., a phone number associated with a user associated with the card and/or an account associated with the card) and a risk signal set employed by the transaction processing entity for purposes of card provisioning (e.g., with payment processing entities). The data to be exchanged can also include data relating to a wallet or other account maintained by the transaction processing entity, such as a device identifier, a wallet identifier, a server session identifier, and a client session identifier.

As another example, the systems and methods described herein provide for a sequence of operations to be performed by the transaction processing entity and another entity, such as a card entity associated with the issuance and/or validation of the contactless card. In some examples, after tapping a card on a client device, an application executing on the client device and associated with the transaction processing entity reads the card and selects an applet to perform authentication and/or card provisioning functions. The application can transmit a card provision request to a server associated with the card entity, and the card provision request can include a payload associated with the applet, a device identifier, a wallet identifier, a server session identifier, a client session identifier, and/or one or more risk signals. The server can perform an authentication and/or validation of the contactless card and/or the card provision request. The server can transmit a push provisioning notification to a server associated with the transaction processing entity, and the push provisioning notification can include a session identifier, a wallet identifier, a OPC, a funding primary account number (FPAN), and an expiration date. The server associated with the transaction processing entity can acknowledge the push provisioning notification in a notification transmitted to the server associated with the card entity. The server associated with the card entity can acknowledge this acknowledgement by transmitting a notification to the application.

As another example, the systems and methods can provide a sequence of operations for provisioning between the transaction processing entity (e.g., an application or a server associated therewith) and the card entity (e.g., an application or a server associated therewith). In some examples, the transaction processing entity can transmit an applet payload, a wallet identifier, a session identifier (e.g., a server session identifier, a client session identifier), a phone number associated with the client device, the user, and/or an account associated with the card, and/or one or more risk signals to card entity. The card entity can provision the card with card information and share the card information with the a backend associated with the transaction processing entity. The transaction processing entity can save the card on file to an account. The transaction processing entity can exchange the applet payload with payment processing networks for the generation of one or more device-specific numbers.

As another example, the systems and methods described herein provide risk signals. Exemplary risk signals can include, without limitation, account age, account change data, account identifier, account risk score, account to device bonding age, customer email, customer phone number, device geolocation, device identifier, device internet protocol (IP) address, device name, device operation system and version, device risk score, primary account number (PAN) and PAN identifier, PAN entry mode, PAN source indicator, payment method attempts, provisioning decision and code, and velocity of usage.

As another example, the systems and methods described herein provide for sequence of operations for a push provisioning application programming interface. In some examples, the application programming interface can be associated with the transaction processing entity. A user can select to add a card for use with the transaction processing entity in an application executing on a client device, and the application may be associated with a card entity. The application can transmit an instruction to create a push provision session to a push provisioning software development kit and the push provisioning software development kit can transmit a device identifier, wallet identifier, and server session identifier to the application. The application can transmit the device identifier, wallet identifier, and session identifier to a backend associated the card entity, and the backend associated with the card entity can acknowledge this transmission by transmitting a notification to the application. The application can transmit an instruction to the push provisioning software development kit to create a server push provision, which can include the device identifier, the wallet identifier, the session identifier, a billing address associated with the card, a user associated with the card, and/or an account associated with the card, and a card display name. The application can then wait on the result of subsequent activity. The backend associated with the card entity can transmit a push provisioning notification, which can include a session identifier, wallet identifier, OPC, FPAN, and expiration date, to the backend associated with the transaction processing entity. The backend associated with the transaction processing entity can acknowledge this notification by transmitting a notification to the backend associated with the card entity. The backend associated with the transaction processing entity can save the card on file to an account with the transaction processing entity. The push provisioning software development kit can provide a device tokenization flow and transmit a notification of the activity result, which can include a token result, a card result, a token reference identifier, and one or more errors notifications, to the application.

As another example, the systems and methods described herein can provide leverage for a tap of card to add a card associated with the transaction processing entity. In some examples, a virtual card number (VCN) can be established and/or enrolled for the card.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® software development kit (SDK) with WebNFC®. For IOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

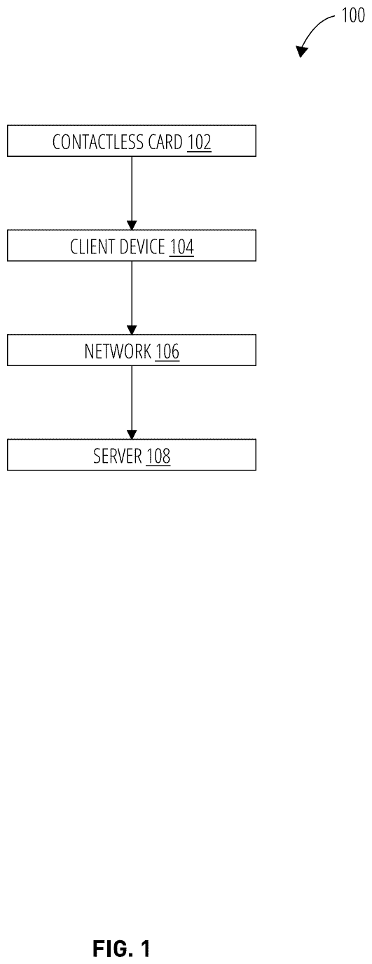

FIG. 1 illustrates a data transmission system 100 according to an example embodiment. As further discussed below, system 100 may include contactless card 102, client device 104, network 106, and server 108. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with client device 104.

System 100 may include client device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 104 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 104 of system 100 may execute one or more applications, such as software applications, that enable, for example, network communications with one or more components of system 100 and transmit and/or receive data.

The client device 104 may be in communication with one or more server(s) 108 via one or more network(s) 106, and may operate as a respective front-end to back-end pair with server 108. The client device 104 may transmit, for example from a mobile device application executing on client device 104, one or more requests to server 108. The one or more requests may be associated with retrieving data from server 108. The server 108 may receive the one or more requests from client device 104. Based on the one or more requests from client device 104, server 108 may be configured to retrieve the requested data from one or more databases (not shown). Based on receipt of the requested data from the one or more databases, server 108 may be configured to transmit the received data to client device 104, the received data being responsive to one or more requests.

System 100 may include one or more networks 106. In some examples, network 106 may be one or more of a wireless network, a wired network or any combination of wireless network and wired network, and may be configured to connect client device 104 to server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof, network 106 may further include one network, or any number of the exemplary types of networks mentioned above, operating as a stand-alone network or in cooperation with each other, network 106 may utilize one or more protocols of one or more network elements to which they are communicatively coupled, network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more servers 108. In some examples, server 108 may include one or more processors, which are coupled to memory. The server 108 may be configured as a central system, server or platform to control and call various data at different times to execute a plurality of workflow actions. Server 108 may be configured to connect to the one or more databases. The server 108 may be connected to at least one client device 104.

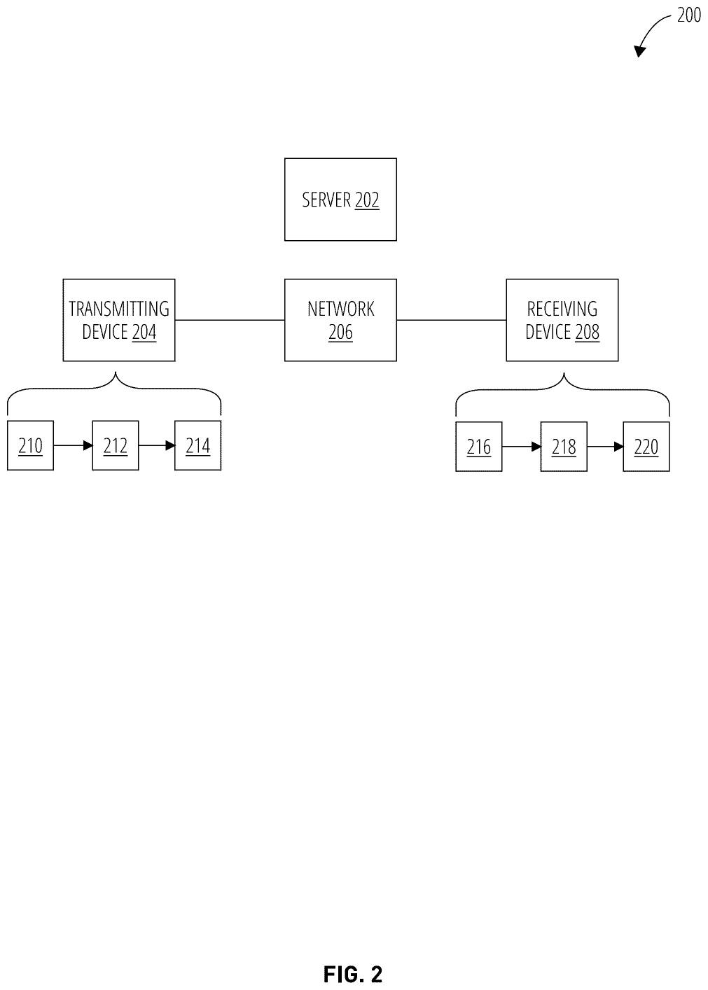

FIG. 2 illustrates a data transmission system according to an example embodiment. System 200 may include a transmitting or transmitting device 204, a receiving or receiving device 208 in communication, for example via network 206, with one or more servers 202. Transmitting or transmitting device 204 may be the same as, or similar to, client device 110 discussed above with reference to FIG. 1A. Receiving or receiving device 208 may be the same as, or similar to, client device 110 discussed above with reference to FIG. 1A. Network 206 may be similar to network 115 discussed above with reference to FIG. 1A. Server 202 may be similar to server 120 discussed above with reference to FIG. 1A. Although FIG. 2 shows single instances of components of system 200, system 200 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 2, system 200 may be configured to implement key diversification. For example, a sender and recipient may desire to exchange data (e.g., original sensitive data) via respective devices 204 and 208. As explained above, although single instances of transmitting device 204 and receiving device 208 may be included, it is understood that one or more transmitting devices 204 and one or more receiving devices 208 may be involved so long as each party shares the same shared secret symmetric key. In some examples, the transmitting device 204 and receiving device 208 may be provisioned with the same master symmetric key. Further, it is understood that any party or device holding the same secret symmetric key may perform the functions of the transmitting device 204 and similarly any party holding the same secret symmetric key may perform the functions of the receiving device 208. In some examples, the symmetric key may comprise the shared secret symmetric key which is kept secret from all parties other than the transmitting device 204 and the receiving device 208 involved in exchanging the secure data. It is further understood that both the transmitting device 204 and receiving device 208 may be provided with the same master symmetric key, and further that part of the data exchanged between the transmitting device 204 and receiving device 208 comprises at least a portion of data which may be referred to as the counter value. The counter value may comprise a number that changes each time data is exchanged between the transmitting device 204 and the receiving device 208.

System 200 may include one or more networks 206. In some examples, network 206 may be one or more of a wireless network, a wired network or any combination of wireless network and wired network, and may be configured to connect one or more transmitting devices 204 and one or more receiving devices 208 to server 202. For example, network 206 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 206 may include, without limitation, telephone lines, fiber optics, IEEE Ethernet 802.3, a wide area network, a wireless personal area network, a LAN, or a global network such as the Internet. In addition, network 206 may support an Internet network, a wireless communication network, a cellular network, or the like, or any combination thereof. Network 206 may further include one network, or any number of the exemplary types of networks mentioned above, operating as a stand-alone network or in cooperation with each other. Network 206 may utilize one or more protocols of one or more network elements to which they are communicatively coupled. Network 206 may translate to or from other protocols to one or more protocols of network devices. Although network 206 is depicted as a single network, it should be appreciated that according to one or more examples, network 206 may comprise a plurality of interconnected networks, such as, for example, the Internet, a service provider's network, a cable television network, corporate networks, such as credit card association networks, and home networks.

In some examples, one or more transmitting devices 204 and one or more receiving devices 208 may be configured to communicate and transmit and receive data between each other without passing through network 206. For example, communication between the one or more transmitting devices 204 and the one or more receiving devices 208 may occur via at least one of NFC, Bluetooth, RFID, Wi-Fi, and/or the like.

At block 210, when the transmitting device 204 is preparing to process the sensitive data with symmetric cryptographic operation, the sender may update a counter. In addition, the transmitting device 204 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 212, the transmitting device 204 may take the selected cryptographic algorithm, and using the master symmetric key, process the counter value. For example, the sender may select a symmetric encryption algorithm, and use a counter which updates with every conversation between the transmitting device 204 and the receiving device 208. The transmitting device 204 may then encrypt the counter value with the selected symmetric encryption algorithm using the master symmetric key, creating a diversified symmetric key.

In some examples, the counter value may not be encrypted. In these examples, the counter value may be transmitted between the transmitting device 204 and the receiving device 208 at block 212 without encryption.

At block 214, the diversified symmetric key may be used to process the sensitive data before transmitting the result to the receiving device 208. For example, the transmitting device 204 may encrypt the sensitive data using a symmetric encryption algorithm using the diversified symmetric key, with the output comprising the protected encrypted data. The transmitting device 204 may then transmit the protected encrypted data, along with the counter value, to the receiving device 208 for processing.

At block 216, the receiving device 208 may first take the counter value and then perform the same symmetric encryption using the counter value as input to the encryption, and the master symmetric key as the key for the encryption. The output of the encryption may be the same diversified symmetric key value that was created by the sender.

At block 218, the receiving device 208 may then take the protected encrypted data and using a symmetric decryption algorithm along with the diversified symmetric key, decrypt the protected encrypted data.

At block 220, as a result of the decrypting the protected encrypted data, the original sensitive data may be revealed.

The next time sensitive data needs to be sent from the sender to the recipient via respective transmitting device 204 and receiving device 208, a different counter value may be selected producing a different diversified symmetric key. By processing the counter value with the master symmetric key and same symmetric cryptographic algorithm, both the transmitting device 204 and receiving device 208 may independently produce the same diversified symmetric key. This diversified symmetric key, not the master symmetric key, is used to protect the sensitive data.

As explained above, both the transmitting device 204 and receiving device 208 each initially possess the shared master symmetric key. The shared master symmetric key is not used to encrypt the original sensitive data. Because the diversified symmetric key is independently created by both the transmitting device 204 and receiving device 208, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 204 and the receiving device 208 may be governed by symmetric requirements for how often to create a new diversification value, and therefore a new diversified symmetric key. In an embodiment, a new diversification value and therefore a new diversified symmetric key may be created for every exchange between the transmitting device 204 and receiving device 208.

In some examples, the key diversification value may comprise the counter value. Other non-limiting examples of the key diversification value include: a random nonce generated each time a new diversified key is needed, the random nonce sent from the transmitting device 204 to the receiving device 208; the full value of a counter value sent from the transmitting device 204 and the receiving device 208; a portion of a counter value sent from the transmitting device 204 and the receiving device 208; a counter independently maintained by the transmitting device 204 and the receiving device 208 but not sent between the two devices; a one-time-passcode exchanged between the transmitting device 204 and the receiving device 208; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 204 and the receiving device 208. In effect, this may create a one-time use key, such as a single-use session key.

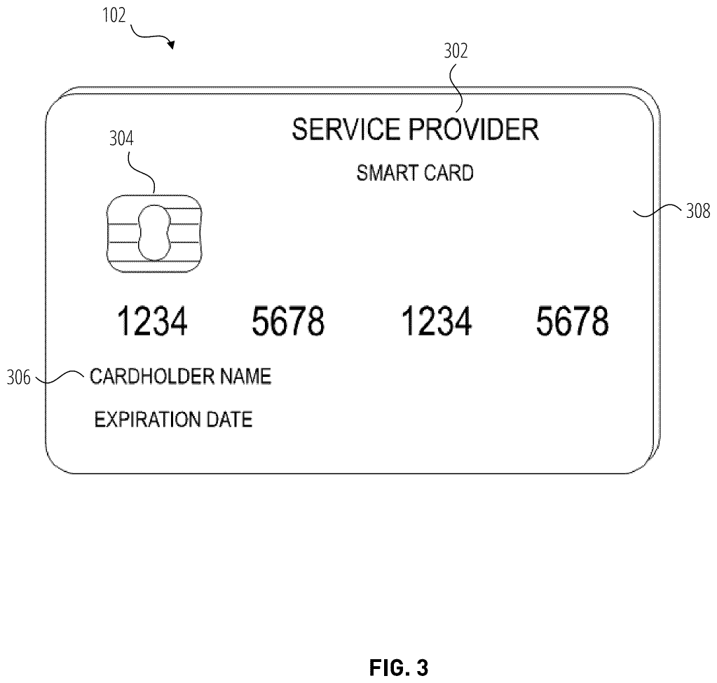

FIG. 3 illustrates an example configuration of a contactless card 102, which may include a contactless card, a payment card, such as a credit card, debit card, or gift card, issued by a service provider as displayed as service provider indicia 302 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

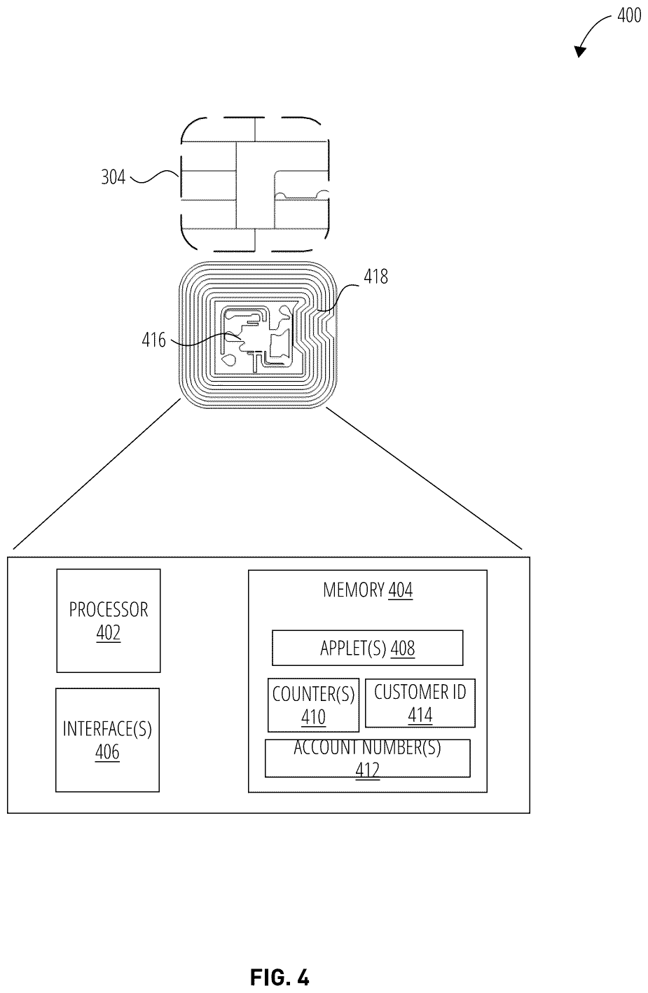

The contactless card 102 may also include identification information 306 displayed on the front and/or back of the card, and a contact pad 304. The contact pad 304 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 4. These components may be located behind the contact pad 304 or elsewhere on the substrate 308, e.g. within a different layer of the substrate 308, and may electrically and physically coupled with the contact pad 304. The contactless card 102 may also include a magnetic strip or tape, which may be located on the back of the card (not shown in FIG. 3). The contactless card 102 may also include a Near-Field Communication (NFC) device coupled with an antenna capable of communicating via the NFC protocol. Embodiments are not limited in this manner.

As illustrated in FIG. 4, the contact pad 304 of contactless card 102 may include processing circuitry 416 for storing, processing, and communicating information, including a processor 402, a memory 404, and one or more interface(s) 406. It is understood that the processing circuitry 416 may contain additional components, including processors, memories, error and parity/CRC checkers, data encoders, anticollision algorithms, controllers, command decoders, security primitives and tamperproofing hardware, as necessary to perform the functions described herein.

The memory 404 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 404 may be encrypted memory utilizing an encryption algorithm executed by the processor 402 to encrypted data.

The memory 404 may be configured to store one or more applet(s) 408, one or more counter(s) 410, a customer identifier 414, and the account number(s) 412, which may be virtual account numbers. The one or more applet(s) 408 may comprise one or more software applications configured to execute on one or more contactless cards, such as a Java® Card applet. However, it is understood that applet(s) 408 are not limited to Java Card applets, and instead may be any software application operable on contactless cards or other devices having limited memory. The one or more counter(s) 410 may comprise a numeric counter sufficient to store an integer. The customer identifier 414 may comprise a unique alphanumeric identifier assigned to a user of the contactless card 102, and the identifier may distinguish the user of the contactless card from other contactless card users. In some examples, the customer identifier 414 may identify both a customer and an account assigned to that customer and may further identify the contactless card 102 associated with the customer's account. As stated, the account number(s) 412 may include thousands of one-time use virtual account numbers associated with the contactless card 102. An applet(s) 408 of the contactless card 102 may be configured to manage the account number(s) 412 (e.g., to select an account number(s) 412, mark the selected account number(s) 412 as used, and transmit the account number(s) 412 to a mobile device for autofilling by an autofilling service.

The processor 402 and memory elements of the foregoing exemplary embodiments are described with reference to the contact pad 304, but the present disclosure is not limited thereto. It is understood that these elements may be implemented outside of the contact pad 304 or entirely separate from it, or as further elements in addition to processor 402 and memory 404 elements located within the contact pad 304.

In some examples, the 102 may comprise one or more antenna(s) 418. The one or more antenna(s) 418 may be placed within the contactless card 102 and around the processing circuitry 416 of the contact pad 304. For example, the one or more antenna(s) 418 may be integral with the processing circuitry 416 and the one or more antenna(s) 418 may be used with an external booster coil. As another example, the one or more antenna(s) 418 may be external to the contact pad 304 and the processing circuitry 416.

In an embodiment, the coil of contactless card 102 may act as the secondary of an air core transformer. The terminal may communicate with the contactless card 102 by cutting power or amplitude modulation. The contactless card 101 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 418, processor 402, and/or the memory 404, the contactless card 101 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 408 may be added to contactless cards to provide a one-time password (OTP) for multifactor authentication (MFA) in various mobile application-based use cases. Applet(s) 408 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 408 may be configured to encode the OTP as an NDEF type 4 well known type text tag. In some examples, NDEF messages may comprise one or more records. The applet(s) 408 may be configured to add one or more static tag records in addition to the OTP record.

In some examples, the one or more applet(s) 408 may be configured to emulate an RFID tag. The RFID tag may include one or more polymorphic tags. In some examples, each time the tag is read, different cryptographic data is presented that may indicate the authenticity of the contactless card. Based on the one or more applet(s) 408, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 410 may be configured to increment. In some examples, each time data from the contactless card 102 is read (e.g., by a mobile device), the counter(s) 410 is transmitted to the server for validation and determines whether the counter(s) 410 are equal (as part of the validation) to a counter of the server.

The one or more counter(s) 410 may be configured to prevent a replay attack. For example, if a cryptogram has been obtained and replayed, that cryptogram is immediately rejected if the counter(s) 410 has been read or used or otherwise passed over. If the counter(s) 410 has not been used, it may be replayed. In some examples, the counter that is incremented on the card is different from the counter that is incremented for transactions. The contactless card 102 is unable to determine the application transaction counter(s) 410 since there is no communication between applet(s) 408 on the contactless card 102.

In some examples, the counter(s) 410 may get out of sync. In some examples, to account for accidental reads that initiate transactions, such as reading at an angle, the counter(s) 410 may increment but the application does not process the counter(s) 410. In some examples, when the mobile device 10 is woken up, NFC may be enabled and the device 110 may be configured to read available tags, but no action is taken responsive to the reads.

To keep the counter(s) 410 in sync, an application, such as a background application, may be executed that would be configured to detect when the mobile device 110 wakes up and synchronize with the server of a banking system indicating that a read that occurred due to detection to then move the counter 104 forward. In other examples, Hashed One Time Password may be utilized such that a window of mis-synchronization may be accepted. For example, if within a threshold of 10, the counter(s) 410 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 410 increases in the appropriate sequence, then it possible to know that the user has done so.

The key diversification technique described herein with reference to the counter(s) 410, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

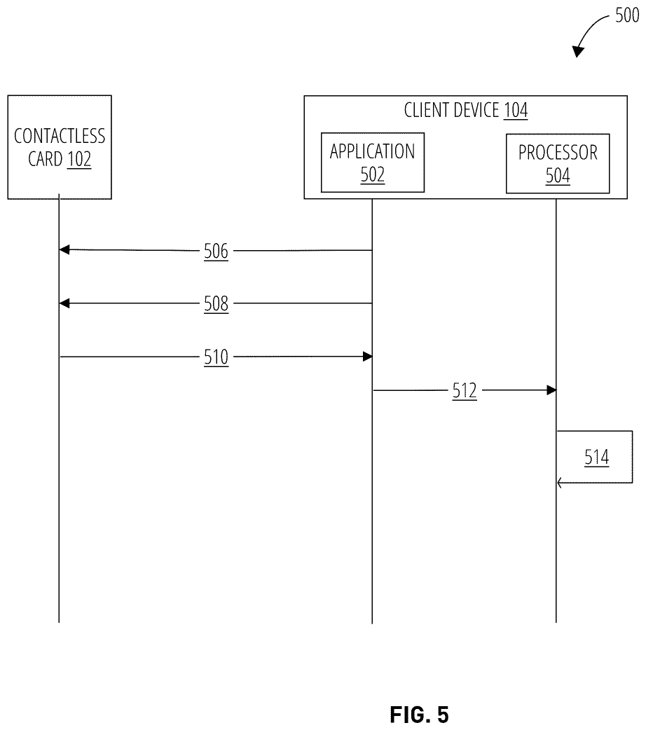

FIG. 5 is a sequence diagram illustrating an example sequence for providing authenticated access according to one or more embodiments of the present disclosure. Sequence flow 500 may include contactless card 102 and client device 104, which may include an application 502 and processor 504.

At line 508, the application 502 communicates with the contactless card 102 (e.g., after being brought near the contactless card 102). Communication between the application 502 and the contactless card 102 may involve the contactless card 102 being sufficiently close to a card reader (not shown) of the client device 104 to enable NFC data transfer between the application 502 and the contactless card 102.

At line 506, after communication has been established between client device 104 and contactless card 102, contactless card 102 generates a message authentication code (MAC) cryptogram. In some examples, this may occur when the contactless card 102 is read by the application 502. In particular, this may occur upon a read, such as an NFC read, of a near field data exchange (NDEF) tag, which may be created in accordance with the NFC Data Exchange Format. For example, a reader application, such as application 502, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 502 may be configured to transmit a request to contactless card 102, the request comprising an instruction to generate a MAC cryptogram.

At line 510, the contactless card 102 sends the MAC cryptogram to the application 502. In some examples, the transmission of the MAC cryptogram occurs via NFC, however, the present disclosure is not limited thereto. In other examples, this communication may occur via Bluetooth, Wi-Fi, or other means of wireless data communication. At line 512, the application 502 communicates the MAC cryptogram to the processor 504.

At line 514, the processor 504 verifies the MAC cryptogram pursuant to an instruction from the application 122. For example, the MAC cryptogram may be verified, as explained below. In some examples, verifying the MAC cryptogram may be performed by a device other than client device 104, such as a server of a banking system in data communication with the client device 104. For example, processor 504 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

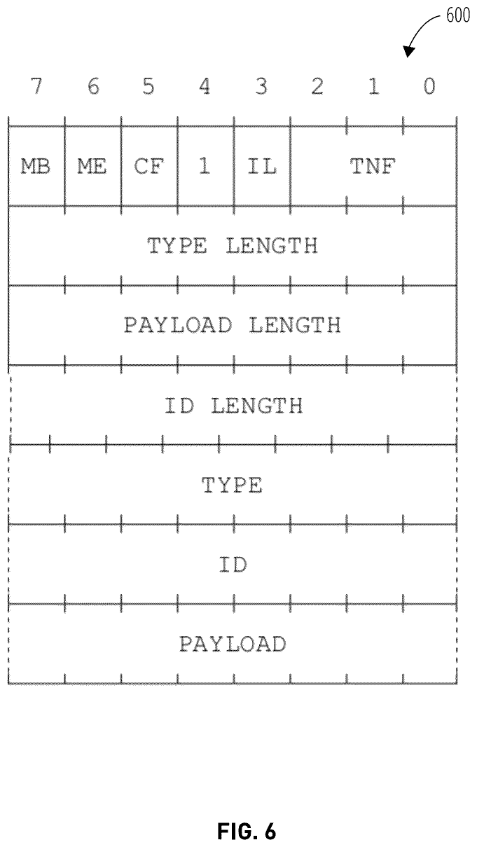

FIG. 6 illustrates an NDEF short-record layout (SR=1) data structure 600 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

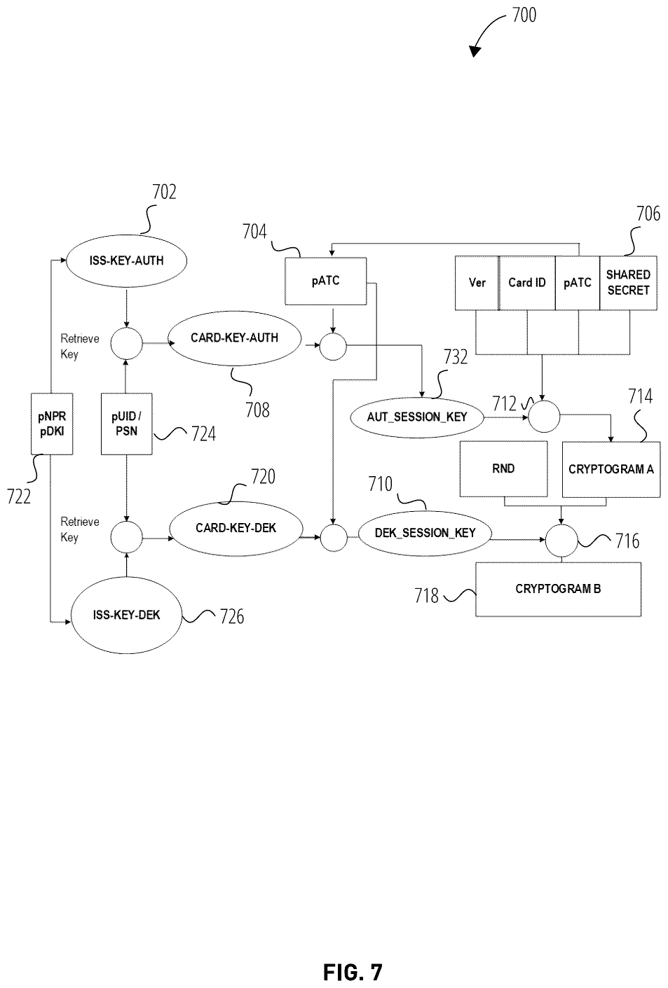

FIG. 7 illustrates a diagram of a system 700 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 702, 726 may be required for each part of the portfolio on which the one or more applets is issued. For example, the first master key 702 may comprise an Issuer Cryptogram Generation/Authentication Key (Iss-Key-Auth) and the second master key 726 may comprise an Issuer Data Encryption Key (Iss-Key-DEK). As further explained herein, two issuer master keys 702, 726 are diversified into card master keys 708, 720, which are unique for each card. In some examples, a network profile record ID (pNPR) 522 and derivation key index (pDKI) 724, as back office data, may be used to identify which Issuer Master Keys 702, 726 to use in the cryptographic processes for authentication. The system performing the authentication may be configured to retrieve values of pNPR 722 and pDKI 724 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four byte session key derivation method may comprise: F1:=PATC (lower 2 bytes)∥‘F0’∥‘00’∥PATC (four bytes) F1:=PATC (lower 2 bytes)∥‘0F’∥‘00’∥PATC (four bytes) SK:={(ALG (MK)[F1])∥ALG (MK) [F2]}, where ALG may include 3DES ECB and MK may include the card unique derived master key.

As described herein, one or more MAC session keys may be derived using the lower two bytes of pATC 704 counter. At each tap of the contactless card, pATC 704 is configured to be updated, and the card master keys Card-Key-AUTH 508 and Card-Key-DEK 720 are further diversified into the session keys Aut-Session-Key 732 and DEK-Session-KEY 710. pATC 704 may be initialized to zero at personalization or applet initialization time. In some examples, the pATC counter 704 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 732, as explained above. As explained above, the low order two bytes of the counter may be used to diversify for the one or more MAC session keys. As explained below, AUT-Session-Key 732 may be used to MAC data 706, and the resulting data or cryptogram A 714 and random number RND may be encrypted using DEK-Session-Key 710 to create cryptogram B or output 718 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 710 derived from the Card-Key-DEK 720. In this case, the ATC value for the session key derivation is the least significant byte of the counter pATC 704.

The format below represents a binary version example embodiment. Further, in some examples, the first byte may be set to ASCII ‘A’.

| | | | | |
|---|---|---|---|---|
| Message Format | | | | |
| 1 | 2 | 4 | 8 | 8 |
| 0x43 (Message Type | Version | pATC | RND | Cryptogram A |
| ‘A’) | | | | (MAC) |
| Cryptogram A | 8 bytes | | | |
| (MAC) | | | | |
| MAC of | | | | |
| 2 | 8 | 4 | 4 | 18 bytes |
| | | | | input data |
| Version | pUID | pATC | Shared | |
| | | | Secret | |
| Message Format | | | | |
| 1 | 2 | 4 | | 16 |
| 0x43 (Message Type | Version | pATC | | Cryptogram B |
| ‘A’) | | | | |
| Cryptogram A (MAC) | 8 bytes | | | |
| MAC of | | | | |
| 2 | 8 | 4 | 4 | 18 bytes input |
| | | | | data |
| Version | pUID | pATC | Shared | |
| | | | Secret | |
| Cryptogram B | 16 | | | |
| Sym Encryption of | | | | |
| 8 | 8 | | | |
| RND | Cryptogram | | | |
| | A | | | |

Another exemplary format is shown below. In this example, the tag may be encoded in hexadecimal format.

| Message | | | | |
|---|---|---|---|---|
| Format | | | | |
| 2 | 8 | 4 | 8 | 8 |
| Version | pUID | pATC | RND | Cryptogram A |
| | | | | (MAC) |
| 8 bytes | | | | |
| 8 | 8 | 4 | 4 | 18 bytes input data |
| pUID | pUID | pATC | Shared | |
| | | | Secret | |
| Message Format | | | | |
| 2 | 8 | 4 | | 16 |
| Version | pUID | pATC | | Cryptogram B |
| 8 bytes | | | | |
| 8 | | 4 | 4 | 18 bytes input data |
| pUID | pUID | pATC | Shared Secret | |
| Cryptogram B | 16 | | | |
| Sym Encryption of | | | | |
| 8 | 8 | | | |

| | |
|---|---|
| RND | Cryptogram A |

The UID field of the received message may be extracted to derive, from master keys Iss-Key-AUTH 502 and Iss-Key-DEK 726, the card master keys (Card-Key-Auth 708 and Card-Key-DEK 720) for that particular card. Using the card master keys (Card-Key-Auth 508 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY, which yields cryptogram A 714 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. The input data 706 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, data 706 is processed through the MAC using Aut-Session-Key 732 to produce MAC output (cryptogram A) 714, which is encrypted.

In order to provide additional protection against brute force attacks exposing the keys on the card, it is desirable that the MAC cryptogram 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 510 to produce encrypted data, cryptogram B 718. The data 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

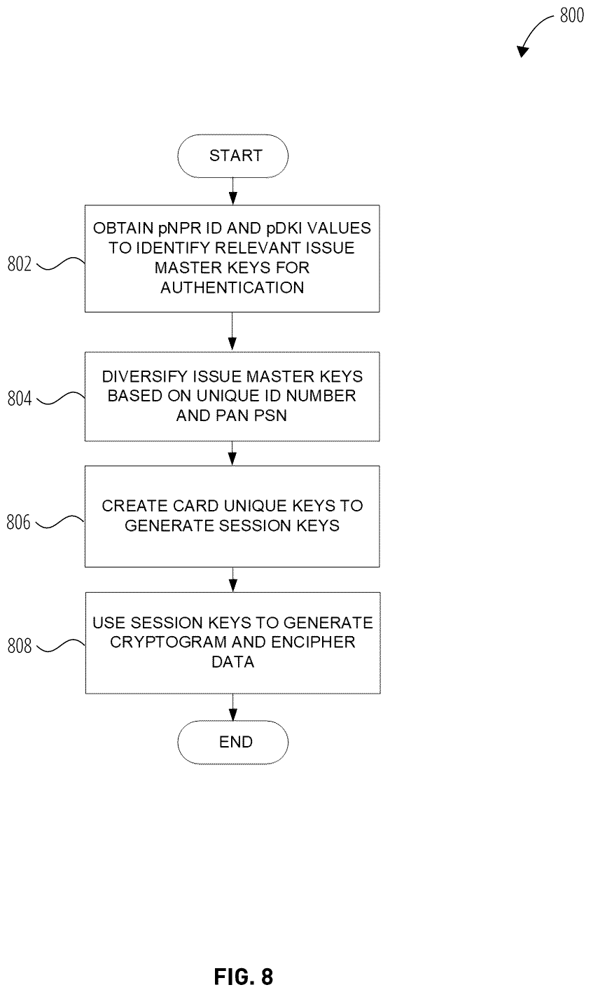

FIG. 8 illustrates a method 800 for generating a cryptogram. For example, at block 802, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 804, Issuer Master Keys may be diversified by combining them with the card's unique ID number (pUID) and the PAN sequence number (PSN) of one or more applets, for example, a payment applet.

At block 806, Card-Key-Auth and Card-Key-DEK (unique card keys) may be created by diversifying the Issuer Master Keys to generate session keys which may be used to generate a MAC cryptogram.

At block 808, the keys used to generate the cryptogram and encipher the data in the one or more applets may comprise the session keys of block 806 based on the card unique keys (Card-Key-Auth and Card-Key-DEK). In some examples, these session keys may be generated by the one or more applets and derived by using pATC, resulting in session keys Aut-Session-Key and DEK-Session-Key.

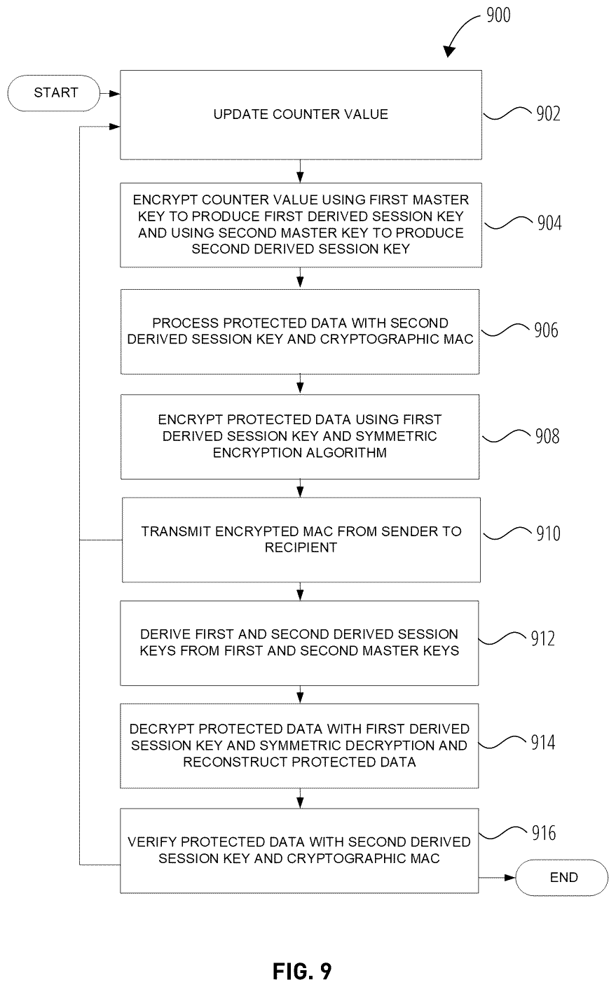

FIG. 9 depicts an exemplary process 900 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 902, and other data, such as data to be protected, which it may secure share with the recipient.

At block 904, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 906, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 908, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 910, the encrypted MAC is transmitted, from the sender to the recipient, with sufficient information to identify additional secret information (such as shared secret, master keys, etc.), for verification of the cryptogram.

At block 912, the recipient uses the received counter value to independently derive the two derived session keys from the two master keys as explained above.

At block 914, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 916, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 902) and a new set of session keys may be created (at block 910). In some examples, the combined random data may be discarded.

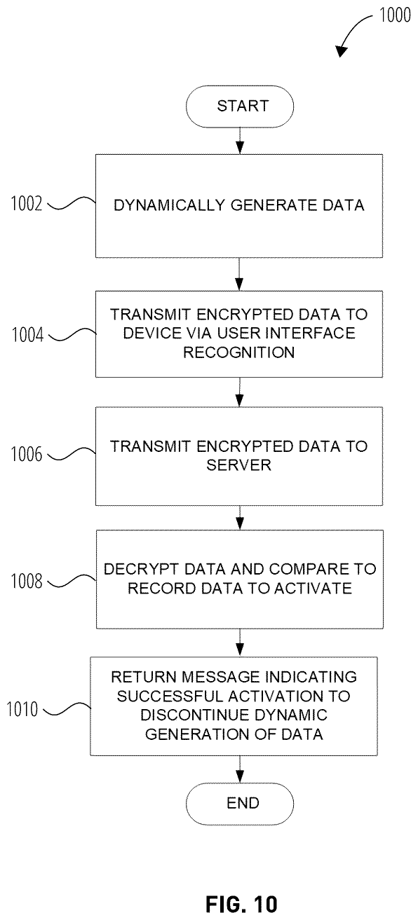

FIG. 10 illustrates a method 1000 for card activation according to an example embodiment. For example, card activation may be completed by a system including a card, a device, and one or more servers. The contactless card, device, and one or more servers may reference same or similar components that were previously explained a, such as contactless card 102, client device 1804, and a server.

In block, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1004, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1006, the one or more portions of the data may be communicated to one or more servers, such as a card issuer server. For example, one or more encrypted portions of the data may be transmitted from the device to the card issuer server for activation of the card.

In block 1008, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1010, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

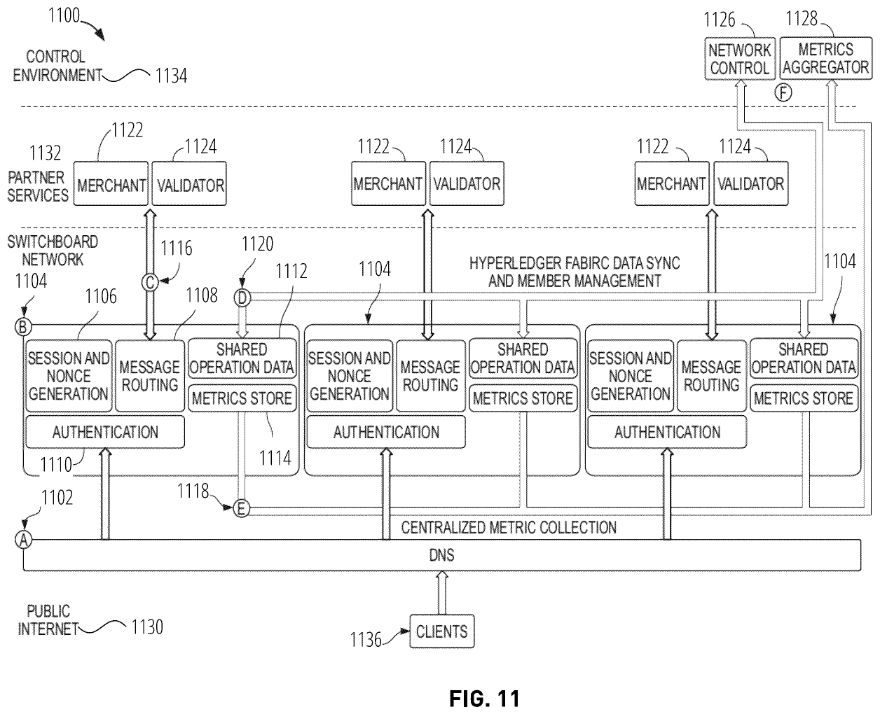

FIG. 11 illustrates an example of system 1100 in accordance with the embodiments discussed herein. The system 1100 includes additional devices and systems configured to enable contactless card issuers to tap-to-card services. Specifically, system 1100 enables any number of issuer systems to provide card services to their clients through a switching fabric, i.e., the switchboard system in a secure and safe manner.

In embodiments, the switchboard system includes one or more nodes 1104 configured to perform routing operations. Each switchboard node 1104 may include a session and nonce generator 1106, a message router 1108, an authentication 1110, an operation data 1112 store, and a metrics store 1114. Further, each of the nodes may be configured the same and share configurations, but each switchboard node 1104 may independently process and route messages and requests to the appropriate systems, such as the merchant systems and issuer systems. Each of the nodes 1104 is configured to act as a broker of trust between an issuer system, the merchant system 1122, and/or validation system 1124, for example. Each switchboard node 1104 is configured to route each message to the correct issuer system while maintaining data security. For example, a switchboard node 1104 may route a message between an issuer system and a merchant system while the node cannot access the private data in the message.

The switchboard system 1100 may be configured as a server system with a collection of hardware, software, and networking components that work together to provide client services. Hardware components may include one or more server computers, storage devices, and network adapters. The server computers are configured to run server applications, such as those executable on each of the nodes 1104. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

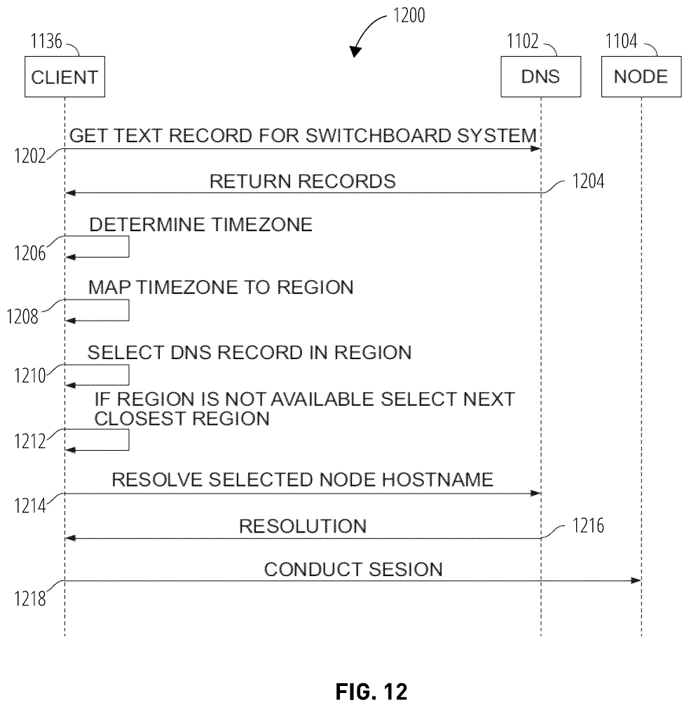

In some embodiments, the nodes 1104 may operate in a cloud-based computing environment, e.g., a collection of hardware, software, and networking components that enable the delivery of cloud computing services. The switchboard nodes 1104 and the computing services are delivered over the Internet and can be accessed from anywhere in the world with an Internet connection. In embodiments, client 1136 may access a switchboard node 1104 through DNS 1102 or Domain Name System (DNS). The DNS 1102 is a hierarchical and distributed naming system for computers, services, and other resources connected to the Internet or other networks. It associates various information with domain names assigned to each registered participant. In one example, the DNS 1102 may translate a name known to software executing on a client 1136 to route data to one or more of switchboard node 1104 of the switchboard system. In embodiments, the DNS 1102 may generate a number, such as an Internet Protocol (IP) address, an address record (A-record), or another Hostname (C-name record). FIG. 12 illustrates one example sequence 1200 for a client to identify and resolve an identifier for one of the nodes 1104 of the switchboard system. At a high level, the DNS 1102 translates known domain names to numerical Internet Protocol (IP) addresses needed for locating and identifying computer services and devices with the underlying network protocols. Clients use the global DNS system to select the best node to use, as discussed in sequence 1200.

In embodiments, a client 1136 communicates with the switchboard system to perform one or more of the partner services 1132, such as conducting a transaction with a merchant, validating the customer, or other tap-to functions. Once client 1136 identifies a switchboard node 1104 and resolves an address to communicate with switchboard node 1104, client 1136 may send one or more messages to switchboard node 1104 to authenticate and perform the operation. The switchboard node 1104 includes an authentication 1110 function that is configured to authenticate the client 1136. In embodiments, the client 1136 sends a message or authorization request to the switchboard node 1104 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client ID | Individual identifier of client |
| GReyx5BuEAaE72bWbFZJfHRL8Dbt1Uum | Client Key | Randomly assigned key |

The switchboard node 1104 may authorize or authenticate the client 1136 or user, and the switchboard node 1104 may utilize the additional components, such as the session and nonce session and node generator 1106 and message router 1108, to perform the operations. Note the validation systems validation system 1124 never interact with the merchant systems 1122, nor vice versa. The nodes node 1104 brokers all communication.

In embodiments, the switchboard system may utilize a hyper ledger fabric 1120 to manage to synchronize the shared operation data 1112 and member management across the network. The hyperledger fabric 1120 is distributed ledger framework having a permissioned network model that only authorized participants can join the network and access the data that is stored on a ledger.

In embodiments, the hyperledger fabric 1120 may be generated by creating one or more sets of peers, an ordering service, and a channel. Once the network is created, system 1100 deploys chaincode to the network, or node 1104 is permitted to access the fabric. The chaincode is the code that runs on the blockchain and executes the network control 1126 and operation data 1112 logic code. Once the chaincode is deployed, each of the switchboard nodes 1104 is configured to invoke transactions on the blockchain to add data to the blockchain, e.g., the operational data. A switchboard node 1104 or another device can query the ledger to retrieve data. The ledger is a distributed database that stores all the data added to the blockchain.

All nodes 1104 keep an independently verifiable log of their actions that can be transmitted to a centralized aggregator to build a picture of overall network usage. System 1100 can manage network operation data and management at a central level and have a centralized view of network use, aggregated and abstracted to the appropriate level.

FIG. 12 illustrates an example sequence 1200 for a client to utilize DNS to resolve and communicate with one or more nodes of a switchboard system. The illustrated sequence 1200 includes a client 1136, a DNS 1102, and a switchboard node 1104. At 1202, the sequence 1202 includes the client 1136 sending a request to a default DNS server for a text record switchboard. {domain}.{tld}. The text record may be preconfigured in a client app and/or client SDK. At 1204, the DNS 1102 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      etc.
   Used For determining where there are active nodes
Node Record:
   Name: {nodename}, {operator}.{region}.switchboard.{domain}.{tld}
   Type: A/AAAA or CNAME
   Resolution: Actual node hostname or IP
   Used For: communicating with a node 1104

In embodiments, the client 1136 may determine the current timezone at 1206. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1208, the client 1136 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1210, the client 1136 may identify or select a DNS record option returned at 1204 that is in the region. If there are multiple matches, the client 1136 may select one at random. If there's no node available in a region, the client 1136 may determine and use a data graph of neighboring regions to select a node in the closest region where a node is available at 1212. For example, sa has no node but is connected to na-e where there is a node and so na-e is selected. In some embodiments,

At 1214, the client may resolve a selected node's hostname. In embodiments, the client 1136 may automatically resolve the hostname using the client's HTTP request default resolver. At 1216, the DNS 1102 may return a result. And at 1218, the client 1136 may communicate with a switchboard node 1104 and begin the process to interact with the switchboard.

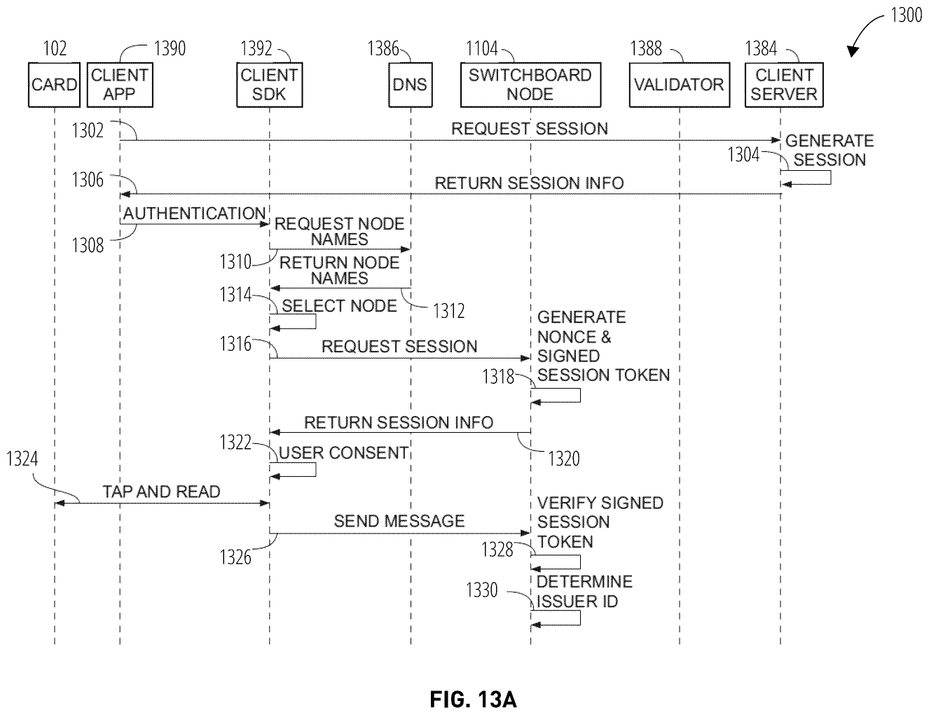

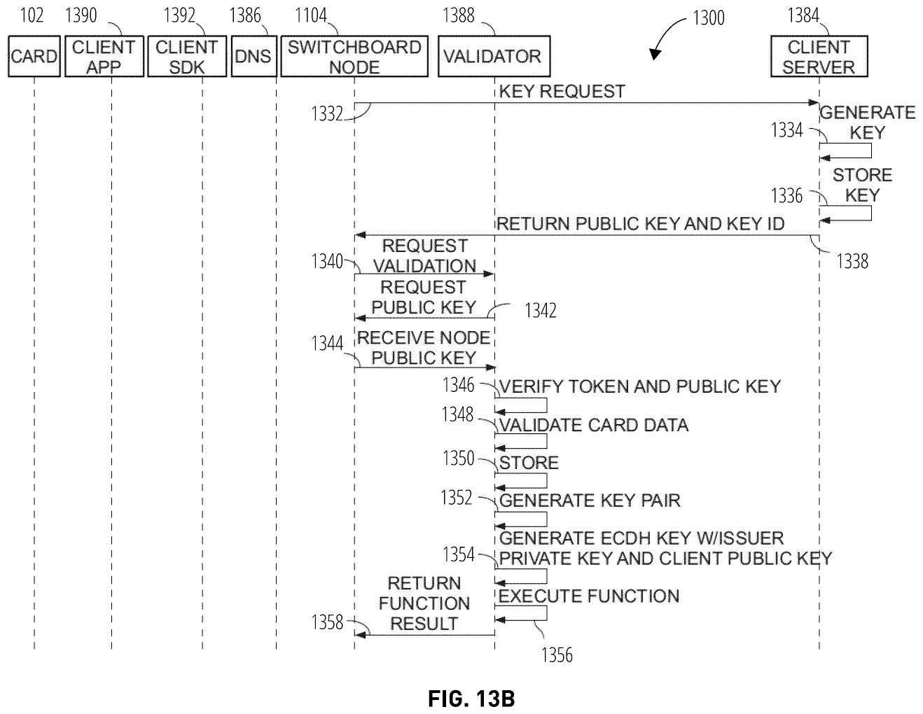

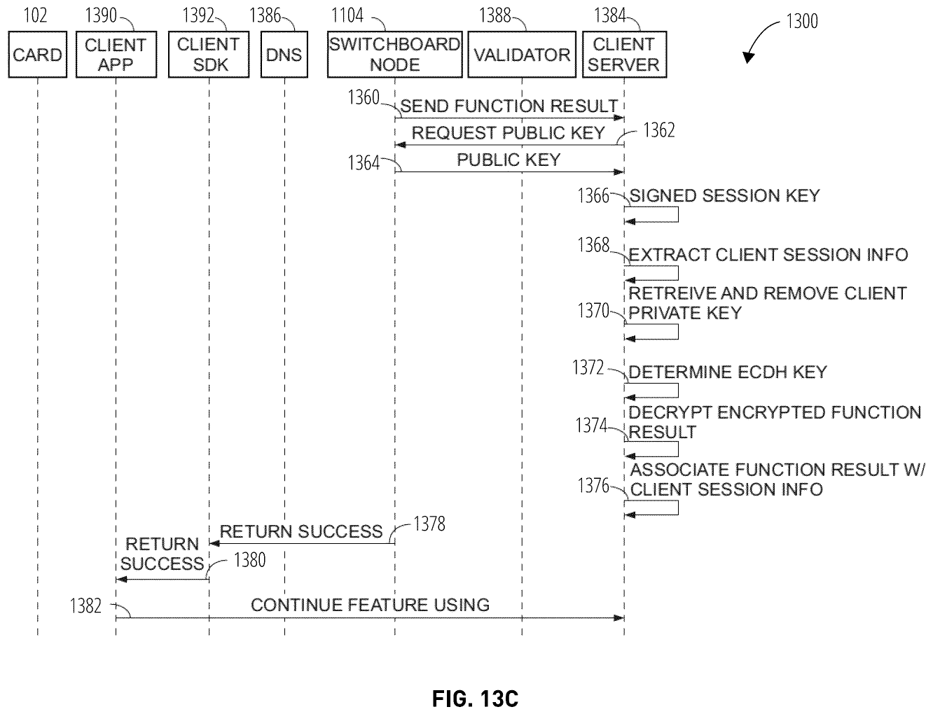

FIG. 13A-FIG. 13C illustrate an example sequence 1300 to perform operations between a contactless card and services provided by a card issuer and/or merchant. The illustrated sequence 1300 includes actions and communications performed by the contactless card 102, a client 1136 including a client application 1390 and a client SDK 1392, a DNS 1386, a switchboard system including one or more nodes 1104, a partner services 1132 including a merchant and/or validator 1388, and control services 1134 including a client server 1384 or system. In embodiments, the client application 1390 may be any application configured to execute on a client 1136, such as a banking app, a merchant app, a social media app, a travel app, a gaming app, a productivity app, an entertainment app, and so forth. In embodiments, the client application 1390 includes a web browser to provide websites and pages. The client application 1390 may include and/or utilize the client SDK 1392, which may be a set of instructions that enable the client application 1390 to communicate with other components of the switchboard system.

In embodiments, as shown in FIG. 13A, at 1302 the client 1136 including the client app may send a request and establish a session with a client server 1384 such that a result may be associated with the correct client device or user. The request establishes a relationship between the client device and client server, which may be an issuer server. At 1304, the client server 1384 generates a session and CLIENT SESSION INFORMATION. At 1306, the client server 1384 returns the session information, e.g., the CLIENT SESSION INFORMATION. In embodiments, the CLIENT SESSION INFORMATION may be the Client implementation-specific user session identification information.

At 1308, the client 1136 may initiate a contactless card authentication process with the client 1136. For example, the client 1136 may call a function and/or pass information to the client 1136 to initiate authentication via a contactless card 102. At 1310-1314, the client 1136 may utilize DNS to identify a node and establish communication with the node. Specifically, at 1310, the client 1136 including the client SDK 1392 may send a request for switchboard hostnames, and at 1312 the the DNS 1386 may return information including one or more hostnames. At 1314, the client 1136 may determine a switchboard node to communicate. FIG. 12 illustrates an example of a more detailed sequence of the process to establish communication with a switchboard node 1104.

At 1316, the client 1136 may send a request for a session to the switchboard system 1100. In embodiments, the request for a session may be for a function request in the format <FUNCTION REQUEST>. In embodiments, the FUNCTION REQUEST may be the data/function that the client 1136 would like to request once a contactless card 102 has been validated. The function could be for any service discussed herein, e.g., authenticate the user, perform a transaction, request autofill data, etc. At 1318, switchboard system 1100 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST>signed with <NODE PRIVATE KEY>, where the NODE PRIVATE KEY is the switchboard system 1100 private key. The switchboard system 1100 may include a NODE PUBLIC/PRIVATE KEY, which is a keypair used to sign and validate JWTs.

At 1320, the switchboard system 1100 may return session information to the client 1136. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1322, the client SDK 1392 may determine and/or receive user consent to the terms of service. In one example, the client SDK 1392 captures and records the user consent to <FUNCTION TOS>on <CONSENT DATE>with<TOS VERSION>. The CONSENT DATE may be the timestamp for the user's consent to the TOS.

At 1324, the client 1136 exchanges one or more messages with a contactless card. In one example, the exchange may be based on the contactless card being tapped to a client device. In embodiments, the client SDK 1392 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX |
| | | encoded 4 bytes binary data |
| 0F . . . 12 | Session Indicators | 4 bytes of ASCII HEX |
| | | encoded 2 bytes binary data |
| 13 . . . 16 | Control Indicators | 4 bytes of ASCII HEX |
| | | encoded 2 bytes binary data |
| 17 . . . 26 | Update Date | 16 bytes of ASCII HEX encoded |
| | creation Time | 8 bytes binary data- |
| | | represents 64 bit unix timestamp |
| 27 . . . 36 | Update MAC | MAC to protect control |
| | | indicators-16 bytes of ASCII |
| | | HEX encoded 8 bytes binary data |

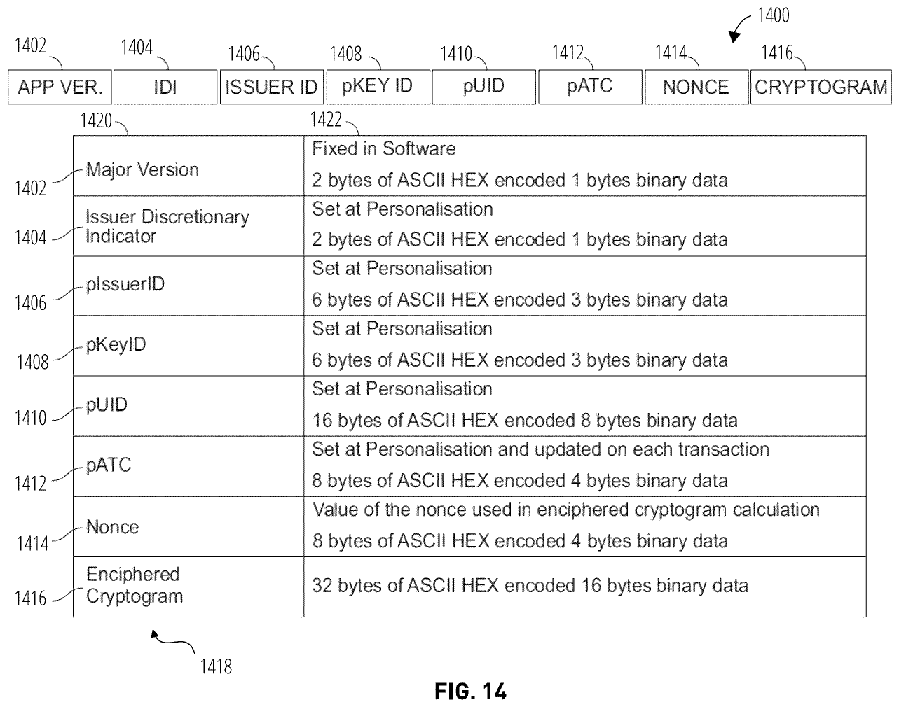

The updated MAC may be calculated to protect the control indicators in embodiments. Specifically, The MAC M is determined by calculating a MAC over the 10 bytes of the update data U with the Update MAC Card Key (MCK), as described in FIG. 14, message 1400.

At 1324, the contactless card may generate and provide a message to the client's device including the client SDK 1392. The data in the message may be utilized by the system discussed herein to perform the function requested. One example of the message is illustrated and discussed in FIG. 14, message 1400.

At 1326, the client including the client SDK 1392 may send a message and information to the switchboard system 1100. The message may be the message received from the contactless card 102, e.g., message 1400. In addition, the client SDK 1392 may send the consent date, the TOS version, and the signed session token to the switchboard system 1100. The switchboard system 1100 may utilize the information to ensure the session is valid. At 1328, the switchboard system 1100 verifies the signed session token is valid, e.g., is the previously provided signed session token and includes the nonce previously generated and is in the message.

In some embodiments, the switchboard system 1100 is configured to determine which issuer system or client-server it should route the message to for processing. At 1330, the switchboard system 1100 may determine the issuer ID by extracting it from the message received from the contactless card 102 via the client SDK 1392. As mentioned, the issuer ID identifies the issuer of the contactless card 102.

FIG. 13B continues the sequence 1300 from FIG. 13A. In embodiments, the switchboard system 1100 is configured to generate and communicate secure communications with the issuer system, e.g., the client server 1384 and the validator 1388. At 1332, the switchboard system 1100 sends a request for a key to the client server 1384. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1334, the client server 1384 generates a portion of the key. In some instances, the client server 1384 may generate half of the ECDH key for encryption/decryption of PII. Specifically, the client server 1384 may generate <CLIENT EC PUBLIC KEY> and <CLIENT EC PRIVATE KEY>using Elliptic Curve P256. The CLIENT EC PUBLIC KEY AND CLIENT EC PRIVATE KEY is the first half of the ECDH key negotiation.

At 1336, the client-server 1384 stores the generated portion of the key in storage. Specifically, the client server 1384 may store <CLIENT EC PUBLIC KEY> and <CLIENT EC PRIVATE KEY>with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1384 may return the public key portion to the switchboard system 1100 with the KEY ID at 1338. The switchboard system 1100 may store the public key portion with the KEY ID for later use, e.g., generation of the ECDH key. At 1340, the switchboard system 1100 may request a validation to be performed by the validator 1388. In one example, the switchboard system 1100 may send a request validation as Request validation <MESSAGE>, <SIGNED SESSION TOKEN>, <CLIENT EC PUBLIC KEY>, <CONSENT DATE>, and the <TOS VERSION>. The validator 1388 may make an out-of-band request back to the switchboard system 1100 for the public key to verify the session at 1342. At 1344, the switchboard system 1100 may provide the node's public key, i.e., <NODE PUBLIC KEY>. Further at 1346, the validator 1388 may utilize the node's public key to verify the secure session token.

In embodiments, the validator 1388 may validate the message at 1348. In embodiments, the validator 1388 may perform a number of validations including ensuring the nonce in the message is correct along with additional information, such as the card's unique identifier (pUID), and the counter value (pATC).

At 1350, the validator 1388 may store information associated with the session. For example, validator 1388 may store the <CONSENT DATE>with the <TOS VERSION> and the <PUID>. The validator 1388 may also generate another portion of the key, e.g., the ECDH key. For example, the 1388 may Generate <ISSUER EC PUBLIC KEY> and <ISSUER EC PRIVATE KEY>using Elliptic Curve P256. The ISSUER EC PUBLIC KEY and ISSUER EC PRIVATE KEY may be the second half of the ECDH key negotiation.

At 1354, the validator 1388 may generate the complete ECDH key. For example, the validator 1388 generates the <ECDH KEY> from <ISSUER EC PRIVATE KEY> and <CLIENT EC PUBLIC KEY>. The ECDH KEY is the final key generated using ECDH key negotiation.

The validator 1388 may utilize the ECDH KEY to encrypt data for the function. For example, if the validator 1388 validates the message in some instances, the validator 1388 may execute a function request to create a function result and encrypt the result with the ECDH KEY at 1356. For example, the validator 1388 may Execute <FUNCTION REQUEST> to create <FUNCTION RESULT> and encrypt it with the <ECDH KEY>. The function result may be any result based on the requested function, e.g., verification of the card.

At 1358, the validator 1388 may return the function result to the switchboard system 1100. In some instances, the function result is returned encrypted. For example, the validator 1388 may return the <ENCRYPTED FUNCTION RESULT> and the <ISSUER EC PUBLIC KEY>.

FIG. 13C continues the sequence 1300 from FIG. 13B. In embodiments, at 1360 the switchboard system 1100 sends the function result to the client server 1384 to process the result. In one example, the switchboard system 1100 may send the <ENCRYPTED FUNCTION RESULT>, <KEY ID>, <ISSUER EC PUBLIC KEY>, and <SIGNED SESSION TOKEN>. At 1362 and 1364, the client server 1384 may make a request for and receive the public key from the switchboard system 1100. In some instances, the exchange may be performed via out-of-band communication channels. The public key for the node may be <NODE PUBLIC KEY>. The public key may be used to verify the sender of the function result, etc. At 1366, the client server 1384 may verify the signed session key with the node's public key <NODE PUBLIC KEY> to verify the sender of the information. At 1368, the client server 1384 may extract client information from the signed session token. For example, the client server 1384 may Extract <CLIENT SESSION INFO> from <SIGNED SESSION TOKEN>, i.e., extracting the client implementation-specific user session identification information.

Further, at 1370, the client server 1384 may retrieve the client's private key with the KEY ID. Specifically, the client server 1384 may get and remove the <CLIENT PRIVATE KEY>from cache using the <KEY ID>. At 1372, the client server 1384 may generate or compute the ECDH key. For example, the client server 1384 may compute the <ECDH KEY>with the <CLIENT PRIVATE KEY>+<ISSUER EC PUBLIC KEY>. The client server 1384 may decrypt the function result with the computed key at 1374. Specifically, the client server 1384 may decrypt the <ENCRYPTED FUNCTION RESULT>with the <ECDH KEY> to determine the <FUNCTION RESULT>. At 1376, the client server 1384 associates the function result with the session.

In embodiments, the switchboard system 1108 may return whether the function result was successfully completed or not at 1378 to the client SDK 1392. Further at 1380, the client SDK 1392 may notify the client application 1390 of the result. At 1382, the client application 1390 may utilize the feature. For example, the 1382 may communicate with the client server 1384 to continue the feature using the <CLIENT SESSION INFO> to fetch the redacted <FUNCTION RESULT>.

FIG. 14 illustrates an example of a message 1400 that may be communicated by a contactless card to perform the functions described herein, such as those discussed in FIG. 13A through FIG. 13C. One or more of the fields in message 1400 may also be utilized to route the message 1400 through the switchboard system and perform authentication/validation techniques.

In embodiments, the message 1400 includes an applet version 1402 field, an issuer discretionary indicator 1404 field, an Issuer Identifier 1406 field, a pKey ID 1408 field, a pUID 1410 field, a pATC 1412 field, a nonce 1414 field, and an encrypted cryptogram 1416.

In embodiments, the fields may be in plain text or encrypted. For example, the applet version 1402 field may include an applet version in plain text. The applet version indicates which applet version is installed on a contactless card and may be used by the other systems to determine how to process the message 1400 when communicated. For example, different Applet versions require different validation logic, e.g., an older message may be routed through the issuer system to perform various operations for validation, while a newer message may be routed through the switchboard system to perform the various operations, including validation.

In embodiments, the message 1400 includes an issuer discretionary indicator 1404 field that may include issuer data and set at the time of personalization. In addition, the message 1400 includes an Issuer Identifier 1406 field that may include a unique ID assigned to the entity issuing the card, e.g., the issuer. For example, when joining the system, each issuer may be assigned a unique identifier during an onboarding operation. The issuer ID can be used by the switchboard system 1108 to route a message and its contents to the appropriate services that are associated with that particular issuer.

In embodiments, the message 1400 includes a pKey ID 1408 field. In some instances, the pKey ID 1408 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. Processes for deriving the Application Keys (UDKs) are further described with respect to other figures in this disclosure.

The message 1400 may include a pUID 1410 field, including a card unique identifier assigned to the contactless card at personalization time. The pUID 1410 field data may be a combination of alphanumeric characters used to identify each card and associated with a user uniquely.

In embodiments, the message 1400 includes a pATC 1412 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1400 is created, a new session key is derived and utilized to generate one or more portions of the message 1400. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1400 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES (ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES (ASKL) [B], where DES is an encryption algorithm. The contactless card 102 computes B=[B XOR T3], and the contactless card 102 computes B=DES (ASKL) [B]. The contactless card 102 computes B=[B XOR T4], and the contactless card 102 computes B=DES (ASKL) [B]. The contactless card 102 computes B=DES⁻¹ (ASKR) [B], where DES⁻¹ is the reciprocal DES operation, and ASKR is a portion of the ASK, e.g., the right half. The contactless card 102 computes the cryptogram C=DES (ASKL) [B].

In embodiments, a contactless card 102 may also encipher the cryptogram to secure the data further. For example, a contactless card 102 may generate an 8-byte random number [RND] and the card computes E1=DES3 (DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3 (DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹ (DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U =U₁∥U₂. Further, operations may be performed on U₁ and U₂.

Embodiments include applying an algorithm to the first portion (U₁) of the data. In one example, a result B may be computed where B=DES (MCKL) [U1], where DES is a Data Encryption Standard algorithm using a first portion (L) of the MAC Card Key (MCKL).

Further, an additional operation may be performed on the result B. Specifically, the result B may be exclusively or′d (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

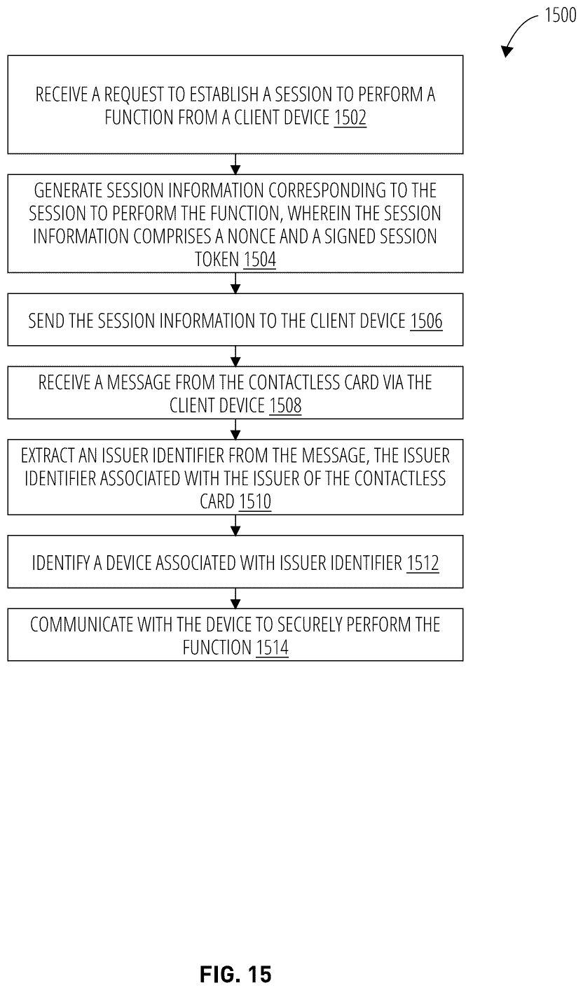

FIG. 15 illustrates an example of method 1500 in accordance with embodiments discussed herein. In block 1502, the method 1500 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1504, the method 1500 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1506, method 1500 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 14).

In block 1508, method 1500 includes receiving, by the node, a message from the contactless card via the client device. The message may be generated by the contactless card. FIG. 14 illustrates one example of a message 1400. In some embodiments, the node verifies the message. For example, the node may verify a nonce in the message and a signed session token.

In block 1510, method 1500 extracts an issuer identifier from the message by the node, the issuer identifier associated with the issuer of the contactless card. In some instances, the issuer identifier may be in a plaintext format.

In block 1512, method 1500 identifies, by the node, a device associated with the issuer identifier. For example, the node may perform a lookup to determine a server associated with the issuer identifier and the function to be performed.

In block 1514, method 1500 communicates, by the node, with the device to securely perform the function.

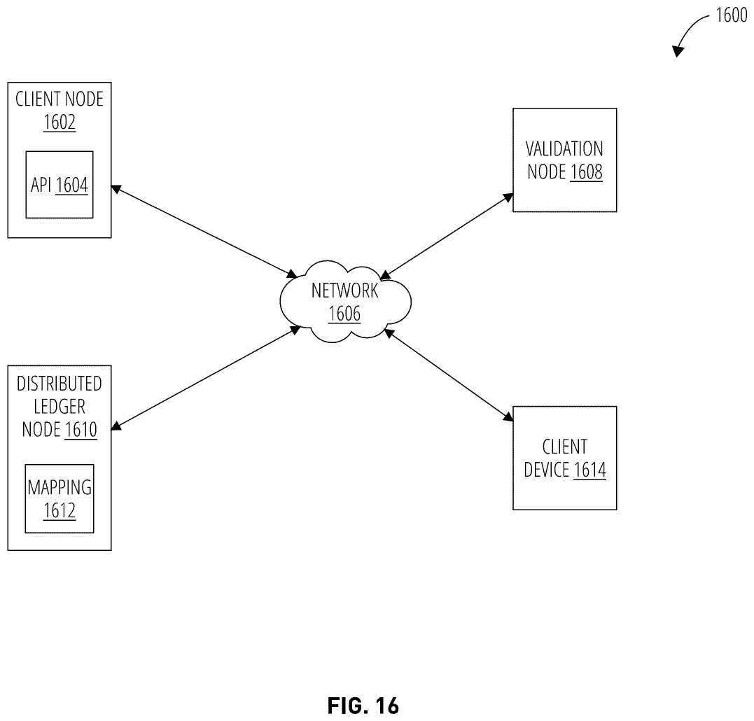

FIG. 16 illustrates a distributed network authentication system 1600 according to an example embodiment. As further discussed below, system 1600 can include client node 1602, API 1604, network 1606, distributed ledger node 1610, mapping 1612, and client device 1614. Although FIG. 16 illustrates single instances of the components, system 1600 can include any number of components.

System 1600 can include a client node 1602, which can be a network-enabled computer as described herein. In some examples, client node 1602 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600.

In some examples, client node 1602 can execute one or more applications, such as software applications, that enable, for example, network communications with one or more components of system 1600, transmit and/or receive data, and perform the functions and processes described herein.

The client node can contain an API 1604. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1604 to interact with the service, such as by performing a remote call to an API for interacting with a web-based service.

API 1604 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1602 can communicate with one or more other components of system 1600 either directly or via network 1606. Network 1606 can comprise one or more of a wireless network, a wired network or any combination of wireless network and wired network, and may be configured to connect the components of system 1600. While FIG. 16 illustrates communication between the components of system 1600 through network 1606, it is understood that any component of system 1600 can communicate directly with another component of system 1600, e.g., without involving network 1606.

System 1600 can include a validation node 1608, which can be a network-enabled computer as described herein. In some examples, validation node 1608 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600.

In some examples, validation node 1608 can execute one or more applications, such as software applications, that enable, for example, network communications with one or more components of system 1600, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1600 can include a distributed ledger node 1610, which can be a network-enabled computer as described herein. In some examples, distributed ledger node 1610 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600.

In some examples, distributed ledger node 1610 can execute one or more applications, such as software applications, that enable, for example, network communications with one or more components of system 1600, transmit and/or receive data, and perform the functions and processes described herein.

Distributed ledger node 1610 can containing a mapping 1612. In some examples, mapping 1612 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1600, or the one or more databases can be hosted externally to any component of the system 1600. In some examples, the one or more databases can be contained in the distributed ledger node 1610, and in other examples the one or more databases can be stored outside of distributed edger node 1610 but in data communication with distributed ledger node 1610. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1610. In other examples, the one or more databases can be remote from distributed ledger node 1610 but in data communication with distributed ledger node 1610. Data communication between the one or more databases and distributed ledger node 1610 can be a direct data communication or data communication via a network, such as the network 1606.

In some examples, client node 1602 can be in data communication with distributed ledger node 1610. Distributed ledger node 1610 can contain mapping 1612. Mapping 1614 may include, e.g., a mapping between a validation node address and the validation node 1608, a mapping between a routing number and a validation node address, and/or a mapping between a routing number and validation node 1608. In some examples, mapping 1612 can include a digital signature associated with an entity having permission to validate for a routing number. Based on one or more of these associations, client node 1602 can call validation node for validation and/or provide direction to the client device to reach the appropriate validation node. This can be accomplished by calling a validation API associated with validation node 1608.

In some examples, iterations of the mappings described herein, such as mapping 1612, can also include a software or applet version number. The version number can be used to identify a validation node or validation node address or choose between multiple validation addresses for one validation node.

In some examples, client node 1602 and distributed ledger node 1610 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1610 can update mapping 1612 to reflect a different association between, e.g., a routing number, a validation node address, and a validation node. In some examples, degrees of permissions can be issued. For example, if client node 1602 were to function to route data to validation node 1608 (or other validation nodes), client node 1602 can be given a certain level of permissions. As another example, if distributed ledger node 1610 were to have the capability to update mapping 1612, distributed ledger node 1610 can have a different, higher level of permissions.

System 1600 can include a client device 1614, which can be a network-enabled computer as described herein. In some examples, distributed ledger node 1614 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600. Client device 1614 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1614 can be in data communication with another network-enabled computer not shown in FIG. 16, such as a smart card (e.g., a contactless card or a contact-based card).

In some examples, client device 1614 can execute one or more applications, such as software applications, that enable, for example, network communications with one or more components of system 1600, transmit and/or receive data, and perform the functions and processes described herein.

In some examples, upon receipt of an authentication request, client device 1614 can call (e.g., via an API) client node 1602. The call can include a routing number and/or an applet or software version number, and client node 1602 can query distributed ledger node 1610 and mapping 1612. Once the query returns the identification of a validation node (e.g., validation node 1608) and/or a validation node address associated with that routing number and/or applet or software version, client node 1602 can reply to client device 1614. Client device 1614 can then proceed with authentication with the validation node. The authentication can be performed by, e.g., the systems and methods described herein, such as by the generation, encryption, transmission, decryption, and validation of a cryptogram as described herein.

In some examples, client node 1602 can be co-resident with validation node 1608. In these examples, client node 1602 can handle the authentication in a single call from client device 1614. In some examples, this can be acceptable only if it is permissible for the full authentication transmission (e.g., a cryptogram as described herein) to be sent to client nodes that are not involved in authentication.

In some examples, if client node 1602 receives, from client device 1614, a routing number that is not handled by its location, client node 1602 can return a code indicating that this routing number is not handled, along with validation node address for the responsible validation node. Client device 1614 can then send the full authentication transmission to validation node 1608 using the received validation node address.

In some examples, client node 1602 can enter the distributed network with different permissions. For example, client node 1602 can be a read-only router of data. As another example, client node 1602 can have permission to send messages to distributed ledger node 1610 updating one or more routing paths for one or more routing numbers. However, client node 1602 would be prevented from updating one or more routing paths for one or more routing numbers for other entities that control other routing numbers which are not associated with client node 1602 or that did not grant this permission. As another example, distributed ledger node 1610 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1602, distributed ledger node 1610, and/or validation node 1608, if security, legal, and/or financial conditions are met, however, delegation is not required.

In some examples, one or more APIs can facilitate communication between components of system 1600 via network 1606. In other examples, one or more APIs are not required. Rather, the components of system 1600 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1608 for authentication, can require storage of the keys in one or more HSMs, to promote key security and ensure that the keys are never entered into memory.

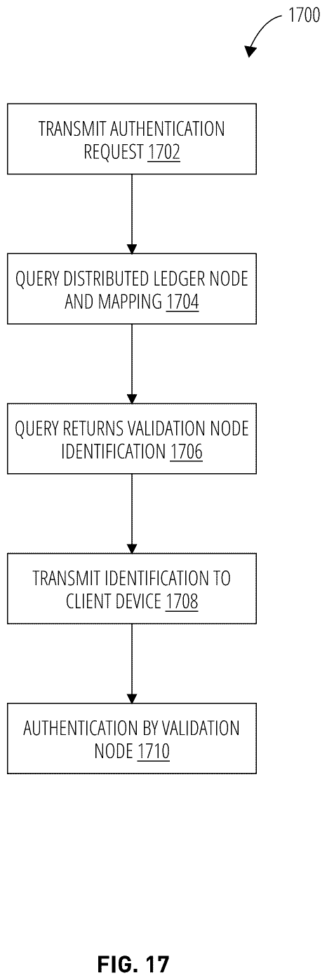

FIG. 17 illustrates a method 1700 performed by a distributed network authentication system according to an example embodiment. For example, the method can be performed by distributed network authentication system 1600 and or by another distributed network authentication system.

In block 1702, a client device can transmit an authentication request to a client node. The authentication request can include, without limitation, a routing number, a software version number, and/or an applet version number. The request can be made by an API call or other communication between the client device and the client node.

In block 1704, after receiving the authentication request, the client node can transmit a query (e.g., via an API call) to a distributed ledger node. The distributed ledger node contain a mapping, and the distributed ledger node can submit the query to the mapping.

In block 1706, the query can return an identification of a validation node and/or a validation node address, and the distributed ledger node can transmit this identification to the client node.

In block 1708, the client node can transmit the identification to the client device. After receiving the identification, the client device can proceed with authentication with the identified validation node and/or validation node address, in block 1710.

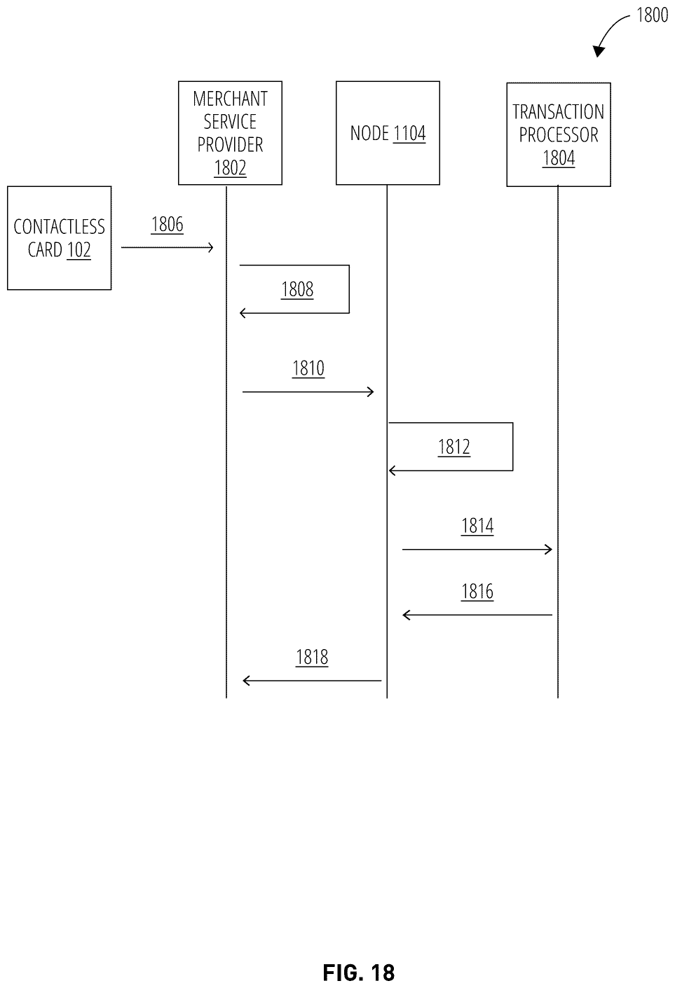

FIG. 18 illustrates a sequence of operations 1800 according to an example embodiment. For example, the sequence of operations 1800 can be performed by components of the data transmission system 100, switchboard system 1100, the distributed authentication system 1600, such as contactless card 102 and node 1104, however it is understood that performance of the sequence of operations 1800 is not limited thereto. In some embodiments, the sequence of operations 1800 can be performed by a merchant service provider 1802, a node 1104, and a transaction processor 1804.

In 1806, a contactless card 102 is tapped onto the merchant service provider 1802, which may be client device as described herein. In some examples, the client device is in data communication with one or more servers associated with the merchant to perform the functions of a merchant service provider. Exemplary merchant service providers can include, without limitation, websites, digital wallets, applications for personal computing devices, mobile computing devices, and point of sale devices. The client device can be configured to present one or more user interfaces to prompt tapping of the contactless card 102, including information, instructions, and terms and conditions related thereto.

In 1808, a read of the contactless card 102, e.g., an NFC read, can be performed during the tap by an application executing on the client device. Through this read, an applet stored in the memory of the contactless card 102 can be identified and selected to perform functions, e.g., authentication and card provisioning functions. In addition, data can be read from the contactless card 102, including data for the above-noted functions.

In 1810, the application can transmit a card provisioning request to the node 1104. The card provisioning can include data associated with the contactless card 102 necessary to initiate provisioning and further, authentication in some embodiments, including, a payload associated with the selected applet, a device identifier, a wallet identifier, a server session identifier, a client session identifier, a funding primary account number (FPAN), an expiration date, and any combination thereof.

In 1812, responsive to receipt of the card provisioning request, the node 1104 can perform validation of the card provisioning request. In some embodiments, the node 1104 can perform one or more authentication processes and/or one or more validation processes, including authentication processes and validation processes described herein.

In 1814, following validation, the node 1104 can transmit a provisioning notification to the transaction processor 1804. The provisioning notification can include provisioning notification to a server associated with the transaction processing entity, and the push provisioning notification can include a sessionID, a walletID, an OPC, an FPAN, and/or an expiration date.

In 1816, responsive to receipt of the provisioning notification, the transaction processor 1804 can transmit a notification indicating receipt of the provisioning notification to the node 1104. In 1818, the node 1104 can further transmit a notification indicating receipt to the merchant service provider 1802.

In some embodiments, a plurality of data exchanges between the transaction processing entity and other entities, such as a card issuing entity or a card validating entity, can be established. In these embodiments, data to be exchanged can include a phone number (e.g., a phone number associated with a user associated with the card and/or an account associated with the card) and a risk signal set employed by the transaction processing entity for purposes of card provisioning (e.g., with payment processing entities). The phone number can be used as one way to verify that the client device receiving the card tap is associated with the user, the card, and/or an account associated with the user and/or the card. The risk signal set can be provided to allow for understanding by the card entity and for use by the card entity to improve future conversion.

Exemplary data to be exchanged can also include data relating to a wallet or other account maintained by the transaction processing entity, such as a device identifier (deviceID), a wallet identifier (walletID), a server session identifier (serverSessionID), and a client session identifier (clientSessionID). In some examples, some or all of this data can be the same as the data generated by a server side push provisioning SDK's when a request to create a push provision session (e.g., createPushProvisionSession) is made. The clientSessionID can be required for a push provisioning notification call (e.g., /pushProvisioningNotification).

In some embodiments, a plurality of operations can be performed by the transaction processing entity and another entity, such as a card entity associated with the issuance and/or validation of the contactless card. After tapping a card on a client device, an application executing on the client device and associated with the transaction processing entity reads the card and selects an applet to perform authentication and/or card provisioning functions. The application can transmit a card provision request to a server associated with the card entity, and the card provision request can include a payload associated with the applet, a deviceID, a walletID, a serverSessionID, a clientSessionID, and/or one or more risk signals. The server can perform an authentication and/or validation of the contactless card and/or the card provision request. The server can transmit a push provisioning notification to a server associated with the transaction processing entity, and the push provisioning notification can include a sessionID, a walletID, an OPC, a funding primary account number (FPAN), and an expiration date. The server associated with the transaction processing entity can acknowledge the push provisioning notification in a notification transmitted to the server associated with the card entity. The server associated with the card entity can acknowledge this acknowledgement by transmitting a notification to the application.

In some embodiments, a plurality of operations for push provisioning between the transaction processing entity (e.g., an application or a server associated therewith) and the card entity (e.g., an application or a server associated therewith) is provided. In some examples, the transaction processing entity can transmit an applet payload, a walletID, a session identifier (e.g., a serverSessionID, a clientSessionID), phone number associated with the client device, the user, and/or an account associated with the card, and/or one or more risk signals to card entity. The card entity can provision the card with card information and share the card information with the a backend associated with the transaction processing entity. The transaction processing entity can save the card on file to an account. The transaction processing entity can exchange the applet payload with payment processing networks for the generation of one or more device-specific numbers (e.g., a device primary account number (DPAN)).

In some embodiments, one or more user interfaces can be presented to provide users with guidance, information, and instructions to facilitate interaction with the systems and methods described herein. For example, one or more user interfaces can provide leverage for a tap of card to add a card associated with the transaction processing entity, for purposes of adjusting settings, adding a payment method, and/or reviewing terms and conditions. In some examples, a virtual card number (VCN) can be established and/or enrolled for the card.

Exemplary user interfaces for use with the systems and methods described herein may include a first user interface that can display a settings menu on a client device. A second user interface can display a payment methods settings menu. A third user interface can display an interface for adding a payment method. A fourth user interface can display adding a card, terms and conditions associated with adding a card, and request for user's consent.

Exemplary user interfaces for use with systems and methods described herein may include a first user interface that can display an instruction and guidance for tapping a card on the client device. A second user interface can display an interface for reading and verifying the tapped card. A third user interface can display saved payment methods, payment on file, and options to choose payment methods.

In some embodiments, one or more user interfaces can be presented to provide users with guidance, information, and instructions to facilitate interaction with the systems and methods described herein. For example, the one or more user interfaces can allow for a user to add a card for use with a transaction processing entity with a tap of the card on a client device. A user can interact with a user interface, such as a user interface presented by the transaction processing entity, for the card tap, a read of the card by the client device, provision of terms and conditions and receipt of a user consent, and the provisioning of the card to the transaction processing entity.

Exemplary user interfaces for use with the systems and methods described herein can include a first user interface to request that a user tap his or her card on the client device. In some examples, the first user interface can be the same as the user interface used for a tap-to-tokenize function (e.g., a Europay, Mastercard, and Visa (EMV) tap-to-tokenize functionality). If an SDK is present on the client device, the SDK can give preference to the systems and methods described herein. A second user interface can display an indication that the card is being read and/or that the card has been read. A card entity brand can be displayed after the card has been read. In some examples, a green path provision can be provided and a yellow path option is not provided. The user will be automatically taken to a consent screen if one or more risk signals pass. A third user interface can display terms and conditions from a card entity for adding a card to a DPAN. In some examples, the DPAN can be associated with the transaction processing entity. The terms and conditions can apply to adding the card as well as other functionality, such as VCN enrollment and auto-filling. A fourth user interface can display a result of adding the card. The card can be displayed as a payment option for use with the transaction processing entity as it has been provisioned to the transaction processing entity.

Exemplary risk signals can include, without limitation: Account Age (the date that the customer opened his or her account with third party); Account Change Date (the date that the customer most recently modified the information on the Third Party Account), Account ID (unique identifier for account holder, e.g., a wallet account holder, which can be a hashed value); Account Risk Score (third party's assessment of the riskiness of the third party account (e.g., 1—High/Red; 5—Low) with reason codes); Account to Device Bonding ID (e.g., an identifier of the bond of the account to this device); Account to Device Bonding Age (number of days this device has been used by this account); Customer Email (Hashed) (email address used with purchase and/or provisioning request, hashed); Customer Name (customer name used with purchase and/or provisioning request); Customer Phone Number (customer phone number used with provisioning); Device Geolocation (latitude/longitude at time of provisioning request); Device ID (a unique identifier, such as a MAC address, international mobile equipment identity (IMEI), other identifier that uniquely identifies the customer's device); Device IP Address (IP address of the device that the customer is using); Device Name (user assigned name of the device); Device Operating System, Version (tags and/or identifiers for device operating system and version); Device Risk Score (third party's assessment of the riskiness of the device (e.g., 1-High/Red; 5-Low) with reason codes); Device Type, Model (device form factor (phone, watch); manufacturer and model); PAN and/or PAN Identifier (Primary Account Number) (in some instances, a proxy identifier for the PAN, such as a PAN hash); PAN Entry Mode (how the user entered the PAN (e.g., camera, manual keying, etc.)); PAN Source Indicator (how the PAN was sourced by Third Party (e.g., wallet, third party property, checkout, etc.)); Payment Method Attempts (the number of attempts to add a payment card to this account over the past 24 hours); Provisioning Decision, Code (a recommendation decision for provisioning and reason codes for recommendation); and velocity of usage (the number of attempted provisions and transactions on this account over a time period, e.g., the past 24 hours, past year).

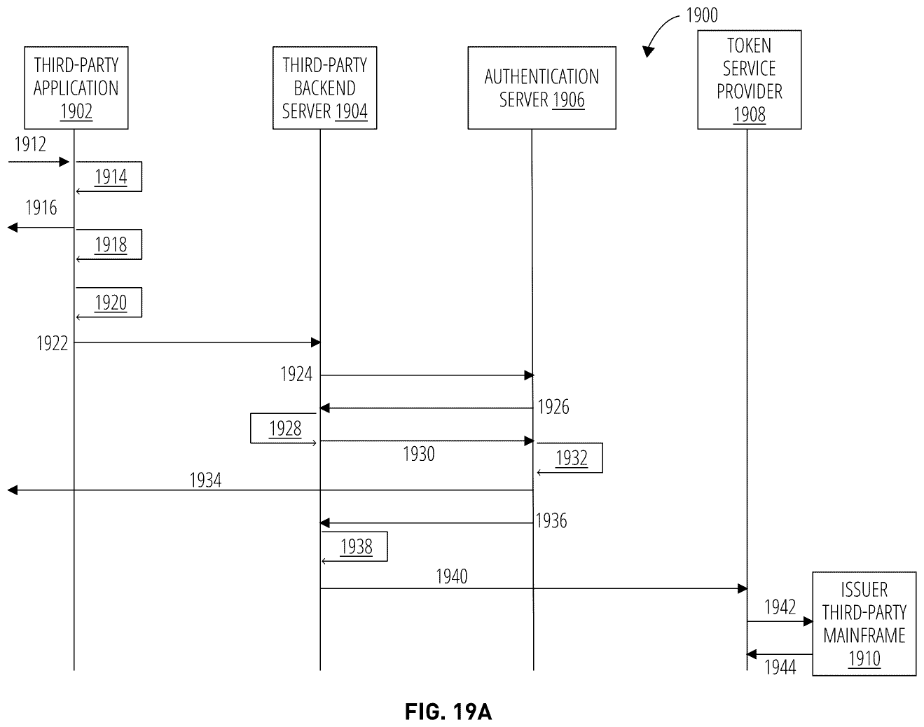

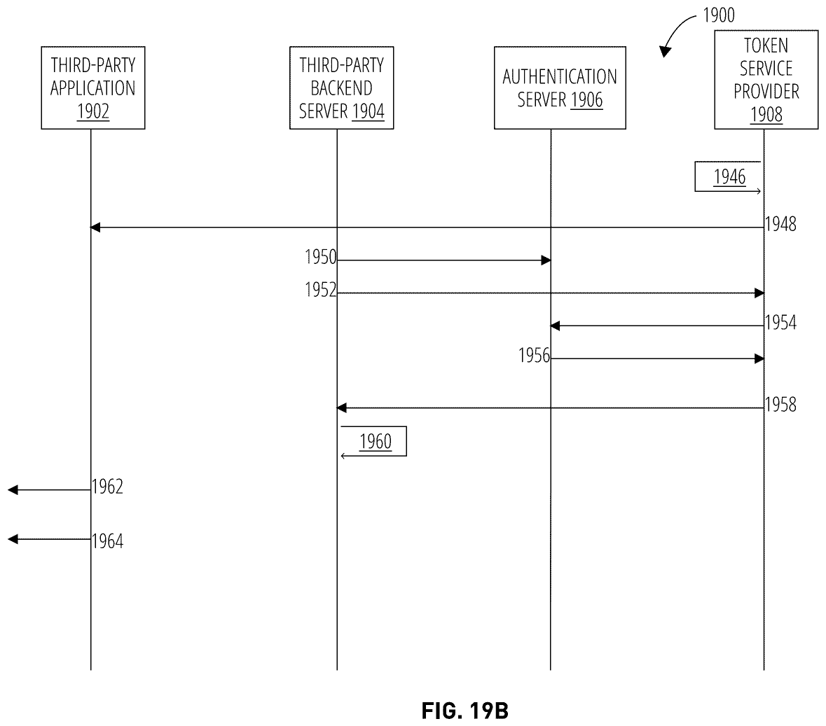

FIG. 19A illustrates an example sequence diagram 1900 of a method for provisioning a form of payment (FoP) on a website, application, or other form of online service in order to perform a payment transaction. In this example sequence diagram 1900, the system includes a third-party application 1902, a third-party backend server 1904, an authentication server 1906, a token service provider 1908, and an issuer third-party mainframe 1910. The third-party application 1902 can include a third party application that accepts a form of payment. For example, the third-party application 1902 can include Google, Apple, Microsoft, PayPal, VenMo, or CashApp payment applications such as Google Wallet, Apple Wallet or Apple Pay, or any other suitable payment application. The third-party application 1902 can further include various applications or websites that accept payments. In the example above, Google's YouTube platform, Play Store, Android applications, or Chrome may be example platforms that accept payment. Similarly, Apple products, Microsoft, PayPal, VenMo, CashApp and and other website or application include applications or website that accept forms of payment. The websites or applications can, for example, be executed on a user's mobile device, such as a smart phone, tablet computer, mobile phone, iPad®, tablet, or any other suitable mobile device.

The third-party backend server 1904 can include the server or other system that operates and maintains the third-party application 1902. For example, the third-party backend server 1904 can include a web server for a web application that accepts payments or for any other website. As another example, the third-party backend server 1904 can include an application server, such as a Google or Apple server that services their respective wallets or payment platforms.

The authentication server 1906 is a server or other system that provides authentication services for the payment transactions. In some examples, the authentication server 1906 can include the authentication server from the switchboard system 1100 described herein. The authentication server 1906 can be controlled and operated by a contactless card issuer or by another entity.

The token service provider 1908 includes, for example, a server operated by a payment card services provider. For example, the token service provider 1908 can be operated and maintained by Visa, Mastercard, American Express, or any other suitable payment card services provider. The issuer third-party mainframe 1910 is a server or services provided by the issuer of a contactless card described herein. The issuer third-party mainframe 1910 is provided to communicate with the token service provider 1908 to verify that the account associated with the contactless card is in good standing and to help perform various other checks to ensure the account is appropriate for provisioning.

At 1912, a user accessing the third-party application 1902 on their mobile device or another computing device selects a button or other icon on their mobile device to add their contactless card, as a form of payment, on the website or application. In some embodiments, the selection of the button or other icon is a selection to add the form of payment by tapping their card. For example, the button or icon displayed by the website or application can include the phrase “Add with a Tap” indicating to the user to “tap” their card to their mobile device to provision their form of payment (e.g., contactless card) to their account on the website or application. In response to the user selecting the button, their phone will then execute an application prompting them to tap their card. The user will then tap their card and at 1914, the mobile device will conduct, for example, an NFC data exchange format (NDEF) read and a Europay, Mastercard, and Visa (EMV) read on the contactless card. In performing the NDEF and EMV reads, the third-party application 1902 is to determine whether the user's contactless card has a particular applet operating thereon. During the NDEF and EMV reads, the third-party application 1902 will obtain encrypted data from the contactless card, including an authentication code and other data regarding the contactless card, such as the card's primary account number (PAN), expiry, CVV, and other data that is encrypted. At 1916, if, the applet is not operating or not present on the contactless card, the provisioning can cease and the third-party backend server 1904 and third-party application 1902 to perform an EMV transaction (or other type of transaction) for the payment transaction.

At 1918, the user device is provided with terms and conditions from the third-party application 1902. On the user's mobile device, the user is asked to accept the terms and conditions. If the user does not accept, the process terminates. However, in sequence diagram 1900, at 1920, the user accepts the terms and conditions provided by the third-party. After the user has accepted the terms and conditions, at 1922, a card provisioning request is sent from the third-party application 1902 to the third-party backend server 1904 to provision the contactless card that was tapped to the user's mobile device at 1912.

At 1924, after the third-party backend server 1904 receives the card provisioning request from the third-party application 1902, the third-party backend server 1904 sends a session creation request to the authentication server 1906 to create a session for provisioning the contactless card to the third-party application 1902. In some embodiments, the session creation request includes a device identifier (ID) for the user's mobile device, a wallet ID of the user if a digital wallet is being used, a session ID of the session, and a client ID. This information is used by the authentication server 1906 to verify with the third-party backend server 1904 that the device ID and wallet ID are available for use by the website or application to which the user wishes to provision their payment method (e.g., the contactless card tapped to the mobile device).

At 1926, a session creation response is sent from the authentication server 1906 to the third-party backend server 1904 indicating that the session has been created and a session token is shared with the third-party backend server 1904. At 1928, the third-party backend server 1904 then generates risk signals. The risk signals are used to help prevent fraud. In some embodiments, the risk signals include a full hashed device phone number tied to the user account with the third-party application 1902. The risk signals further include a full hashed email address tied to the user account with the third-party application 1902. In some embodiments the risk signals may further include risk scores for the user's device and account with the third-party application 1902. The risk signals may further include the internet protocol (IP) address of the user device connecting to the third-party application 1902, a device geolocation of the user device, the user device to account binding identifier (ID), and the device to account age.

At 1930, the third-party backend server 1904 is to send an authentication process function request to the authentication server 1906. The authentication process function request includes the encrypted data from the contactless card, the session ID, consent date, risk signals generated above, wallet ID for the user's digital wallet tied to the third-party application 1902, and the user's device ID.

At 1932, the authentication server 1906 is to decrypt the encrypted data from the contactless card using a decryption algorithm, and compare the decrypted authentication code with an expected authentication code for the contactless card. At 1934, if the authentication is not successful, the authentication server 1906 transmits a notification indicating an unsuccessful notification to the third-party backend server 1904 causing the provisioning process to cease and the third-party backend server 1904 and third-party application 1902 to perform an EMV transaction (or other type of transaction) for the payment transaction. If the authentication is successful, then the authentication server 1906 is configured to assess the risk signals to determine the likelihood that the present provisioning request is fraudulent. Also, at 1934, if the risk assessment indicates that the provisioning request (e.g., the authentication process function request) is likely fraudulent, the authentication server 1906 transmits a notification indicating a fraudulent transaction to the third-party backend server 1904 causing the provisioning process to cease and the third-party backend server 1904 and third-party application 1902 to perform an EMV transaction (or other type of transaction) for the payment transaction.

At 1936, if the authentication is successful and the risk assessment indicates that the provisioning request is not likely fraudulent, then, the authentication server 1906 returns the session ID, wallet ID, encrypted funding primary account number (FPAN), card expiry, address of the user, and/or an OPC to the third-party backend server 1904. If an OPC is not supplied, operations 1940, 1942, 1944, 1946, and 1948 below are skipped and the flow diagram 1900 transitions directly from operation 1938 to 1950. The OPC is optional but can be utilized where the device primary account number (DPAN) for the contactless card is not supported by some applications and websites.

At 1938, the third-party backend server 1904 then stores the FPAN into a data store and associates it with the user account of the user and indicates in the data store that the FPAN for the user account is authenticated. At 1940, the third-party backend server 1904 then sends a request to the token service provider 1908 to enroll the PAN. In this operation, the OPC and session ID is sent, however, the FPAN is not sent because the OPC is being sent.

At 1942, the token service provider 1908 communicates a request to the issuer third-party mainframe 1910 to enroll the PAN in a provisioning process to provision the user's contactless card with the third-party application 1902. The issuer third-party mainframe 1910 assesses the request and determine if the user's account is in good standing. If not, the process terminates and the contactless card is not provisioned to the third-party application 1902. If the user's account is in good standing, at 1944, the issuer third-party mainframe 1910 sends a response to the token service provider 1908 indicating as such.

FIG. 19B is a continuation of sequence diagram 1900 from FIG. 19A. At 1946, the token service provider 1908 checks to ensure that certain parameters are set to properly provision the contactless card to the third-party application 1902. For example, in some embodiments, the token service provider 1908 may check to ensure that a panSource parameter is set to PUSH. In some cases, if the OPC is sent, the token service provider 1908 automatically sets the panSource parameter to PUSH, but otherwise this is an issuer defined rule.

At 1948, the token service provider 1908 returns an activated token to the third-party application 1902 indicating the that contactless card can be provisioned to the user account with the third-party application 1902.

At 1950, the third-party backend server 1904 determines if a bank identification number (BIN) associated with the contactless card permits the user to enroll in a virtual card number (VCN) autofill procedure. If so, the third-party backend server 1904 sends a request for establishing the VCN autofill procedure to the authentication server 1906 and flags the request as already being authenticated.

At 1952, the third-party backend server 1904 sends a credit primary account number (CPAN) creation request to the token service provider 1908. The request includes the FPAN, the session ID, and a CPAN TRID (TILA-RESPA Integrated Disclosure). At 1954, the token service provider 1908 sends a request to the authentication server 1906 to determine whether the account is eligible for the CPAN creation, and the request includes the FPAN, session ID, and CPAN TRID. At 1956, if the account is in good standing, based on an analysis of the FPAN, session ID, and CPAN TRID, the authentication server 1906 sends a message to the token service provider 1908 indicating as such. The 1958, the token service provider 1908 creates the CPAN and sends the CPAN in a message to the third-party backend server 1904. At 1960, the third-party backend server 1904 then stores the generated CPAN and flags the CPAN as being authenticated by the authentication server 1906. The third-party backend server 1904 then takes the contactless card information and provisions the card with the digital wallet or otherwise saves the contactless card as a form of payment associated with the third-party application 1902.

At 1962, the verified FPAN is stored on file by the third-party application 1902 and is flagged or indicated as being authenticated using the authentication server 1906. The DPAN is used for transactions with the third-party application 1902 and at 1964, the CPAN is used to store the contactless card information on file with the third-party application 1902.

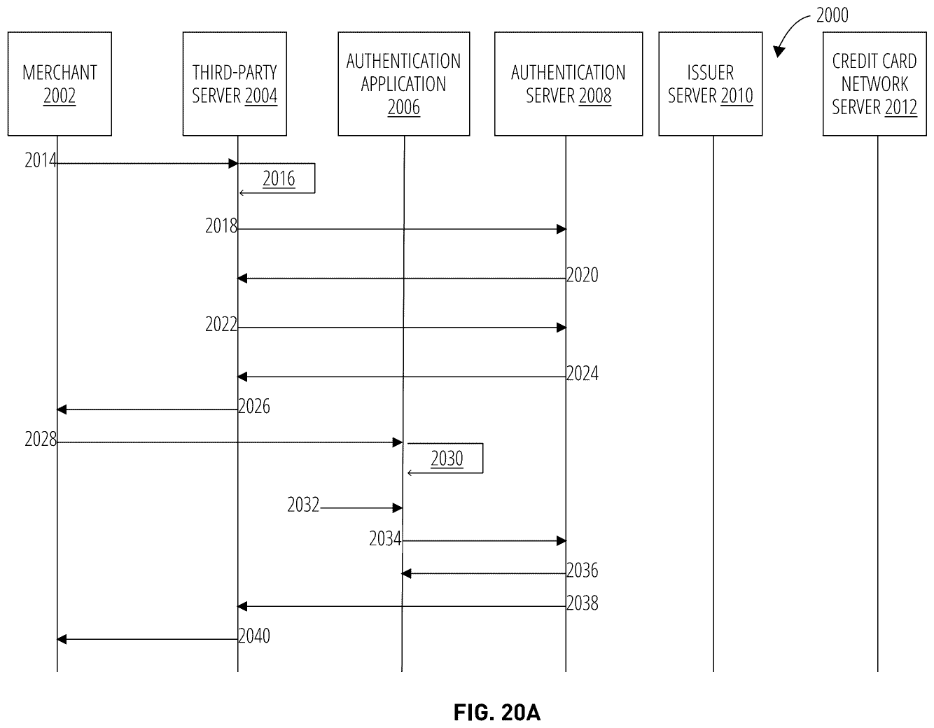

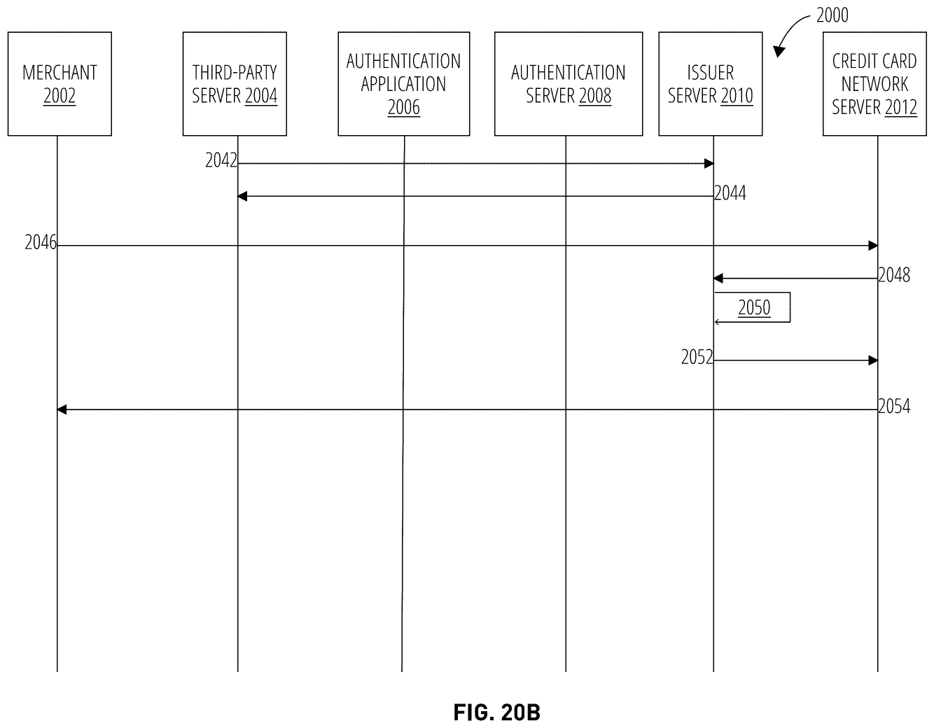

FIG. 20A is a flow diagram 2000 that illustrates one example embodiment of a system for improving merchant card not present (CNP) approvals and transactions. In some embodiments, the system includes a merchant 2002 (e.g., a merchant server associated with the merchant), a third-party server 2004, an authentication application 2006, an authentication server 2008, an issuer server 2010, and a credit card network server 2012. In some embodiments, the merchant 2002 may be at a point of sale (POS) system or on an online merchant website. For example, the merchant 2002 may have physical sales locations as well as an online store. A transaction request from a user can be received at the physical sales location (e.g., at a POS system) or the transaction can be initiated on the online store or on a mobile application for the merchant.

The third-party server 2004 can be maintained and operated by an organization used for facilitating identity verification, payment optimization, and fraud prevention. The authentication application 2006 is a front end service provided by the authentication server 2008. For example, the authentication application 2006 can produce a pop-up or other application that provides prompts and other data to a user's mobile device to prompt the user to initiate an authentication process. The authentication server 2008 operates the backend systems that communicate with the authentication application 2006 to help authenticate a user account. The authentication server 2008 is further configured to provide authentication features to decrypt and verify authentication codes.

The issuer server 2010 is a server maintained by a contactless card issuer and performs various operations as described herein. The credit card network server 2012 is a credit card network device operated and maintained by one or more credit card network companies.

At 2014, the merchant 2002 receives a transaction request from a user having a contactless card. In response to the transaction request from the user, the merchant 2002 sends a message to the third-party server 2004 to initialize a pre-authorization validation process.

At 2016, the third-party server 2004 determines whether the user has a contactless card capable of communicating with the authentication application 2006 and authentication server 2008 to perform authentication of the contactless card. In some cases, the bank identification number (BIN) range of the contactless card can be used to determine if the contactless card is capable of communicating with the authentication application 2006 and authentication server 2008 for authentication. Alternatively, the merchant 2002 can also be provided with the user's contact information, such as their phone number, and the user's contact information and the BIN (and/or BIN range) are used to determine whether the contactless card of the user or another card owned by the user is capable of communicating with the authentication application 2006 and authentication server 2008 for authentication.

At 2018, the third-party server 2004 sends a request to the authentication server 2008 to initiate an authentication session to authenticate the contactless card, and therefore the identity of the user. At 2020, in response to the request, the authentication server 2008 returns to the third-party server 2004 a JavaScript Object Notation (JSON) Web Token (JWT) in order to facilitate authentication of the contactless card by the authentication server 2008. At 2022, in response to receiving the JWT, the third-party server 2004 sends a request to the authentication server 2008 for an authentication experience universal resource locator (URL). Alternatively a quick response (QR) code can be requested. At 2024, the authentication server 2008 sends the authentication experience URL (or QR code) to the third-party server 2004 and at 2026, the URL or QR code is sent to the merchant 2002 for display to the user on their mobile device or on their desktop computer. The URL or QR code can also be displayed on a POS system of the merchant.

At 2028, the merchant 2002 displays the URL to the user for the user to select and the user selects the URL. Alternatively, if the transaction is being conducted on a POS or on the user's desktop, the QR code can be displayed and the user can scan the QR code on their mobile device. By either selecting the URL or scanning the QR code on their mobile device, an authentication application is initiated on the user's mobile device and an authentication session is created between the merchant 2002 and the authentication application 2006. At 2030, the authentication application 2006 launches the authentication experience and the user is prompted to tap their contactless card to their mobile device. At 2032, the user taps their card to the mobile device and, in response, encrypted data is sent from the contactless card to the mobile device and then forwarded to the authentication application 2006 for authentication. The encrypted data includes, inter alia, an encrypted authentication code to verify the identity of the user and the contactless card.

At 2034, the encrypted data, including the authentication code is sent to the authentication server 2008 to decrypt the encrypted data, including the authentication code, using a decryption algorithm. At 2036, the authentication server 2008 sends a message to the authentication application 2006 indicating that the encrypted data was successfully decrypted and the authentication code verified or validated. At 2038, the authentication server 2008 sends a similar message indicating that the encrypted data was successfully decrypted to the third-party server 2004. At 2040, the third-party server 2004 sends a pre-authorization response to the merchant 2002 indicating that the authentication request was validated and the contactless card is authorized to be used for the transaction. This validates that the user has physical possession of the card and is not likely a fraudulent transaction.

FIG. 20B is a continuation of the sequence diagram 2000 from FIG. 20A. At 2042, the third-party server 2004 sends a message submitting enhanced decisioning data (EDD) with an authentication result flag to the issuer server 2010. The authentication result flag indicates that the contactless card has been authenticated by the authentication server 2008. In response, at 2044, the issuer server 2010 sends a unique transaction reference identifier (ID) back to the third-party server 2004.

At 2046, the merchant 2002 submits an authorization request to the credit card network server 2012 to authorize the transaction. In some embodiments, operation 2046 and operation 2042 are performed simultaneously. Operations 2042 and 2044 represent an enhanced decisioning process between the third-party server 2004 and the issuer server 2010 whereas operations 2046 and others that follow are operations performed between the merchant 2002, the issuer server 2010, and the credit card network server 2012.

At 2048, the credit card network server 2012 forwards or sends the transaction request to the issuer server 2010 and at 2050, the issuer server 2010 calculates the fraud risk using a rules engine, and the fraud risk is calculated by factoring in the authentication result from operation 2036. At 2052, the issuer server 2010 sends a response to the credit card network server 2012 indicating that the fraud risk is low and authorizing the transaction to proceed. At 2054, the credit card network server 2012 sends the merchant 2002 a message indicating that the transaction request is authorized and the merchant 2002 is permitted to allow the transaction to proceed.

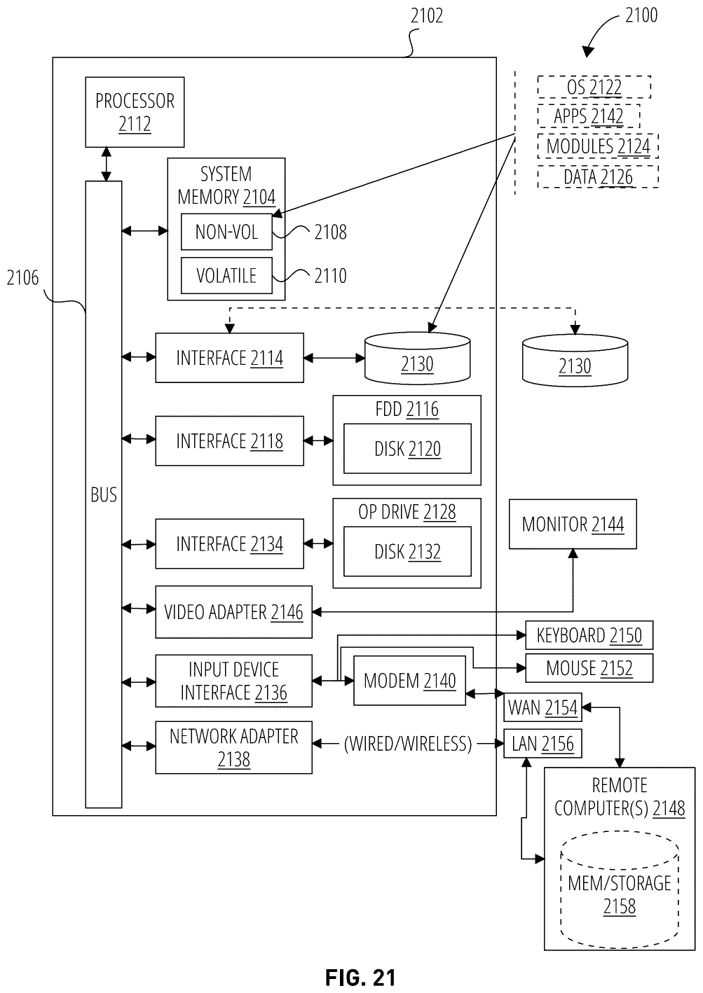

FIG. 21 illustrates an embodiment of an exemplary computer architecture 2100 suitable for implementing various embodiments as previously described. In one embodiment, the computer architecture 2100 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 2100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 21, the computing architecture 100 includes a processor 2112, a system memory 2104 and a system bus 2106. The processor 2112 can be any of various commercially available processors.

The system bus 2106 provides an interface for system components including, but not limited to, the system memory 2104 to the processor 2112. The system bus 2106 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2104 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 21, the system memory 2104 can include non-volatile 2108 and/or volatile 2110. A basic input/output system (BIOS) can be stored in the non-volatile 2108.

The computer 2102 may include various types of computer-readable storage media in the form of one or more lower speed memory units, including an internal (or external) hard disk drive 2130, a magnetic disk drive 2116 to read from or write to a removable magnetic disk 2120, and an optical disk drive 2128 to read from or write to a removable optical disk 2132 (e.g., a CD-ROM or DVD). The hard disk drive 2130, magnetic disk drive 2116 and optical disk drive 2128 can be connected to system bus 2106 the by an HDD interface 2114, and FDD interface 2118 and an optical disk drive interface 2134, respectively. The HDD interface 2114 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 2108, and volatile 2110, including an operating system 2122, one or more applications 2142, other program modules 2124, and program data 2126. In one embodiment, the one or more applications 2142, other program modules 2124, and program data 2126 can include, for example, the various applications and/or components of the systems discussed herein.

A user can enter commands and information into the computer 2102 through one or more wire/wireless input devices, for example, a keyboard 2150 and a pointing device, such as a mouse 2152. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 2112 through an input device interface 2136 that is coupled to the system bus 2106 but can be connected by other interfaces such as a parallel port, IEEE 1394 serial port, a game port, a USB port, an IR interface, and so forth.

A monitor 2144 or other type of display device is also connected to the system bus 2106 via an interface, such as a video adapter 2146. The monitor 2144 may be internal or external to the computer 2102. In addition to the monitor 2144, a computer typically includes other peripheral output devices, such as speakers, printers, and so forth.

The computer 2102 may operate in a networked environment using logical connections via wire and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all the elements described relative to the computer 2102, although, for purposes of brevity, only a memory and/or storage device 2158 is illustrated. The logical connections depicted include wire/wireless connectivity to a local area network 2156 and/or larger networks, for example, a wide area network 2154. Such LAN and WAN networking environments are commonplace in offices and companies, and facilitate enterprise-wide computer networks, such as intranets, all of which may connect to a global communications network, for example, the Internet.

When used in a local area network 2156 networking environment, the computer 2102 is connected to the local area network 2156 through a wire and/or wireless communication network interface or network adapter 2138. The network adapter 2138 can facilitate wire and/or wireless communications to the local area network 2156, which may also include a wireless access point disposed thereon for communicating with the wireless functionality of the network adapter 2138.

When used in a wide area network 2154 networking environment, the computer 2102 can include a modem 2140, or is connected to a communications server on the wide area network 2154 or has other means for establishing communications over the wide area network 2154, such as by way of the Internet. The modem 2140, which can be internal or external and a wire and/or wireless device, connects to the system bus 2106 via the input device interface 2136. In a networked environment, program modules depicted relative to the computer 2102, or portions thereof, can be stored in the remote memory and/or storage device 2158. It will be appreciated that the network connections shown are exemplary and other means of establishing a communications link between the computers can be used.

The computer 2102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

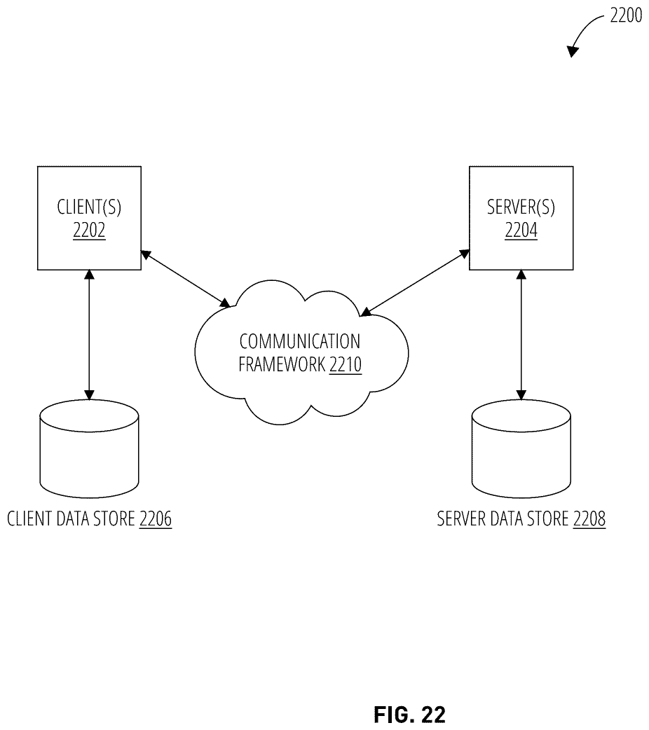

FIG. 22 is a block diagram depicting an exemplary communications architecture 2200 suitable for implementing various embodiments as previously described. The communications architecture 2200 includes various common communications elements, such as a transmitter, receiver, transceiver, radio, network interface, baseband processor, antenna, amplifiers, filters, power supplies, and so forth. The embodiments, however, are not limited to implementation by the communications architecture 2200, which may be consistent with systems and devices discussed herein.

As shown in FIG. 22, the communications architecture 2200 includes one or more client(s) 2202 and server(s) 2204. The server(s) 2204 may implement one or more functions and embodiments discussed herein. The client(s) 2202 and the server(s) 2204 are operatively connected to one or more respective client data store 2206 and server data store 2208 that can be employed to store information local to the respective client(s) 2202 and server(s) 2204, such as cookies and/or associated contextual information.

The client(s) 2202 and the server(s) 2204 may communicate information between each other using a communication framework 2210. The communication framework 2210 may implement any well-known communications techniques and protocols. The communication framework 2210 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2210 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 2202 and the server(s) 2204. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

As described herein, the systems and methods of the present disclosure provide numerous benefits. For example, systems and methods of the present disclosure can provide a single tap transaction flow for a contactless card through first party and third party entry points. This transaction flow can support card provisioning and enrollment for transactions using DPANs, CPANs, VCNs, and FPANs, as described herein. Transaction flows as described herein result in a higher conversion rate for provisioning digital wallets as well as contactless cards. Transaction flows as described herein further result in lower challenge rates for VCN retrievals.

Systems and methods of the present disclosure enable a consistent user interface treatment for transactions. Such transactions can include card authentication and provisioning transactions as described herein as well as EMV transactions and other transactions. As described herein, if an authentication or validation process is unsuccessful, an EMV transaction or other transaction can be performed.

By reusing existing provisioning flows where applicable, and systems and methods of the present disclosure can achieve lower implementation costs. In addition, lower implementation costs can be achieved by a employing a single implementation pattern for authentication and validation transactions, whereas EMV transactions often require different implementations.

Systems and methods of the present disclosure can, using verified CPANs and FPANs, obtain lower first party and third party fraud rates. In addition, improved authentications can be obtained using verified CPANs and FPANs for transactions.

Systems and methods of the present disclosure enable additional means of identity verifications. Such identity verifications may be unavailable for EMV transactions.

Systems and methods of the present disclosure can promote transaction performance through improved read latencies. The read latencies achieved by systems and methods of the present disclosure demonstrate improved read latencies when compared with EMV transactions.

Systems and methods of the present disclosure can reduce risk associated with CNP approvals and transactions by improving the balance between declining fraudulent transactions and not falsely declining legitimate transactions. Through the authentication and validation provided by the systems and methods described herein, a transaction can be found to be legitimate and approved even in view of risk signals that would that would cause the transaction be falsely declined as fraudulent.

It is noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Throughout the present disclosure, reference is made to a card, such as a contact-based card and a contactless card.” It is understood that the present disclosure is not limited to a particular type of card, and instead this disclosure encompasses a contact-based card, a contactless card, or any other card. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

As used herein, the term “card entity” can include, without limitation, financial institutions (e.g., banks). However, it is understood that the term “card entity” is not limited thereto, and the present disclosure can include corporations, state, local, and federal governments, and any other entity issuing, personalizing, activating, authenticating, and/or validating cards for use in transactions.

As used herein, the term “tap” can include, without limitation, a tap of a card on a device. However, it is understood that the term “tap” is not limited to a particular gesture, and the present disclosure can include a tap, a swipe, a wave, and/or any combination thereof.

As used herein, the term “transaction” can include, without limitation, financial transactions. However, it is understood that the term “transaction” is not limited thereto, and the present disclosure can include financial transactions, identity verification transactions, area access transactions, user authentication transactions, membership verification transactions, eligibility verification transactions, and any other operation involving a card.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A transaction provisioning system, comprising:
an authentication server in data communication, comprising:
a processor, and
a memory storing an expected authentication code for a contactless card, wherein the authentication server:
receives, from a backend server, a session creation request for provisioning the contactless card,
transmits, to the backend server, a session creation response and a session token,
receives, from the backend server, an authentication process function request comprising encrypted data associated with the contactless card,
decrypts the encrypted data to yield a decrypted authentication code,
compares the decrypted authentication code to the expected authentication code,
transmits, after an unsuccessful comparison, a notification indicating an unsuccessful authentication to the backend server, and
transmits, after a successful comparison, a session identifier associated with the session creation request and a funding primary account number.

2. The transaction provisioning system of claim 1, wherein the authentication server:
receives, from the backend server, a request to establish a virtual card number (VCN) autofill procedure,
receives, from a token server, an eligibility request associated with the contactless card, and
transmit, to the token server after determining the contactless card is eligible, a notification indicating eligibility.

3. The transaction provisioning system of claim 1, wherein the authentication function request further comprises at least one selected from the group of the session identifier, a consent date, and a device identifier.

4. The transaction provisioning system of claim 3, wherein the authentication function request further comprises a wallet identifier associated with a digital wallet.

5. The transaction provisioning system of claim 3, wherein the authentication function request comprises one or more risk signals.

6. The transaction provisioning system of claim 5, wherein the one or more risk signals comprises at least one selected from the group of a device phone number, an email address, an account risk score, a device risk score, an internet protocol (IP) address, a device geolocation, an account to device bonding identifier, and a device to account bonding age.

7. The transaction provisioning system of claim 6, wherein the device phone number and the email address are hashed.

8. The transaction provisioning system of claim 1, wherein:
the authentication process function request further comprises one or more risk signals, and
the one or more risk signals are generated by the backend server.

9. The transaction provisioning system of claim 8, wherein prior to transmitting the session identifier and the encrypted funding primary account number, the authentication server:
assesses the one or more risk signals, and
transmits, to the backend server after determining the authentication process function request is fraudulent based on the one or more risk signals, a notification indicating a fraudulent transaction.

10. The transaction provisioning system of claim 8, wherein the authentication server:
assesses the one or more risk signals, and
determines, prior to transmitting the session identifier and the encrypted funding primary account number, that the authentication process function request is not fraudulent based on the one or more risk signals.

11. A transaction provisioning method performed by an authentication server comprising a processor and a memory, the method comprising:
receiving, from a backend server, a session creation request for provisioning a contactless card;
transmitting, to the backend server, a session creation response and a session token;
receiving, from the backend server, an authentication process function request comprising encrypted data associated with the contactless card;
decrypting the encrypted data to yield a decrypted authentication code;
comparing the decrypted authentication code to an expected authentication code associated for the contactless card;
transmitting, after an unsuccessful comparison, a notification indicating an unsuccessful authentication to the backend server; and
transmitting, after a successful comparison, a session identifier associated with the session creation request and a funding primary account number.

12. The method of claim 11, wherein the funding primary account number is encrypted prior to transmission.

13. The method of claim 11, wherein:
the authentication process function request further comprises one or more risk signals, and
the one or more risk signals are generated by the backend server.

14. The method of claim 13, further comprising, prior to transmitting the session identifier and the encrypted funding primary account number:
assessing the one or more risk signals; and
transmitting, to the backend server after determining the authentication process function request is fraudulent based on the one or more risk signals, a notification indicating a fraudulent transaction.

15. The method of claim 13, further comprising:
assessing the one or more risk signals; and
determining, prior to transmitting the session identifier and the encrypted funding primary account number, that the authentication process function request is not fraudulent based on the one or more risk signals.

16. The method of claim 11, wherein the authentication function request further comprises at least one selected from the group of the session identifier, a consent date, and a device identifier.

17. The method of claim 11, wherein the authentication function request further comprises a wallet identifier associated with a digital wallet.

18. A non-transitory computer readable medium containing instructions, wherein, upon execution by a processor, the instructions cause the processor to perform procedures comprising:
receiving, from a backend server, a session creation request for provisioning a contactless card;
transmitting, to the backend server, a session creation response and a session token;
receiving, from the backend server, an authentication process function request comprising encrypted data associated with the contactless card;
decrypting the encrypted data to yield a decrypted authentication code;
comparing the decrypted authentication code to an expected authentication code associated for the contactless card;
transmitting, after an unsuccessful comparison, a notification indicating an unsuccessful authentication to the backend server; and
transmitting, after a successful comparison, a session identifier associated with the session creation request and a funding primary account number.

19. The non-transitory computer readable medium of claim 18, the procedures further comprising:
receiving, from the backend server, a request to establish a virtual card number (VCN) autofill procedure;
receiving, from a token server, an eligibility request associated with the contactless card; and
transmitting, to the token server after determining the contactless card is eligible, a notification indicating eligibility.

20. The non-transitory computer readable medium of claim 18, wherein the authentication function request further comprises at least one selected from the group of the session identifier, a consent date, and a device identifier.
